(19) United States
(12) Patent Application Publication
(10) Pub. No.: US 2026/0368122 A1
(43) Pub. Date: Nov. 19, 2026

(54) MANAGING HOT-SWAP COMPONENTS IN COMPUTING DEVICES

(71) Applicant: Aivres Systems Inc., Fremont, CA (US)

(72) Inventor: WEN-CHI SHEN, New Taipei City (TW)

(21) Appl. No.: 19/726,673

(22) Filed: Jun. 30, 2026

(51) Int. Cl. G06F 13/40; G06F 1/20; G06F 1/26

(52) U.S. Cl. CPC G06F 13/4081; G06F 1/206; G06F 1/26

(57) ABSTRACT

Devices, systems, methods, and techniques for managing hot-swap components in computing devices are provided. In one aspect, a device includes: a hot-swap detection module configured to detect a physical movement of a target component into the device and generate an event signal, a power control module configured to regulate a power supply to the target component, a thermal control module configured to regulate a cooling capacity of a physical zone corresponding to the target component, and a controller communicatively coupled to the hot-swap detection module, the power control module, and the thermal control module. The controller is configured to: receive the event signal from the hot-swap detection module; and in response to receiving the event signal, coordinate a power control response and a thermal control response.

### TECHNICAL FIELD

The present disclosure is related to computing devices, particularly for computing devices with hot-swap components.

### BACKGROUND

As data centers advance toward higher power densities and high-availability architectures, computing devices may need to support seamless hot-swapping of electronic components such as hard drives and memory modules without disrupting system operations.

### SUMMARY

The present disclosure describes devices, systems, methods, and techniques for managing hot-swap components in computing devices.

One aspect of the present disclosure features a device including: a hot-swap detection module configured to detect a physical movement of a target component into the device and generate an event signal; a power control module configured to regulate a power supply to the target component; a thermal control module configured to regulate a cooling capacity of a physical zone corresponding to the target component; and a controller communicatively coupled to the hot-swap detection module, the power control module, and the thermal control module. The controller is configured to: receive the event signal from the hot-swap detection module; and in response to receiving the event signal, coordinate a power control response and a thermal control response.

Another aspect of the present disclosure features a device including: a hot-swap detection module including a first channel configured to detect a mechanical state of a target component and a second channel configured to detect an electrical state of the target component, where the hot-swap detection module is configured to detect a physical movement of the target component into the device and generate an event signal based on the mechanical state and the electrical state; a power control module configured to regulate a power supply to the target component; and a controller communicatively coupled to the hot-swap detection module and the power control module. The controller is configured to: receive the event signal from the hot-swap detection module; and in response to receiving the event signal, generate a power control response for the target component.

A further aspect of the present disclosure features a method for managing a hot-swap event in a device. The method includes: detecting, via a hot-swap detection module, a physical movement of a target component into the device; generating an event signal based on the physical movement; receiving, by a controller, the event signal; and in response to receiving the event signal, coordinating a power control response and a thermal control response by commanding a power control module to regulate a power supply to the target component and commanding a thermal control module to regulate a cooling capacity of a physical zone corresponding to the target component.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 illustrates a schematic view of an example computing device with hot-swap components.

FIG. 2 illustrates another example computing device with a cooling module.

FIG. 3 illustrates an example hot-swap event based control architecture in a computing device.

FIG. 4 is a flow chart of a process for a hot-swap event based control method.

FIG. 5 illustrates an example dual-channel detection mechanism in a computing device.

FIG. 6 illustrates an example hot-swap event based control for coordinated power and thermal responses.

FIG. 7 is a flow chart of a process of an artificial intelligence (AI) predictive module.

FIGS. 8A-8E illustrate an example physical system for detection of hot-swap components.

FIG. 9 illustrates an example computing device.

FIG. 10 illustrates an example computing system.

Like reference numbers and designations in the various drawings indicate like elements.

### DETAILED DESCRIPTION

Hot swap (or Hot Plug) is a technology designed to increase operational flexibility and ease of maintenance for electronic devices. Hot swap technology can be used in data centers, industrial automation equipment and consumer electronics. In some cases, hot-swap implementations may be passive and operate their power and cooling subsystems independently, which can lead to critical system-level vulnerabilities during the physical plugging and unplugging of hot-swap electronic components.

Implementations of the present disclosure provide methods, devices, systems, and techniques for managing hot-swap components in computing devices such as servers. The techniques introduce a paradigm shift from a reactive model to a proactive, event-driven, system-level collaborative control architecture, through which high-density server environments can safely handle hot-swaps by pre-emptively managing both power and heat, ensuring uninterrupted uptime and protecting hardware lifespan.

A system implemented herein can utilize a physical hot-swap event as a unified trigger to coordinate both power and cooling responses before a hot-swap component's electrical demand and thermal load are fully established. The system can achieve this through several highly integrated components as described below.

The first component is dual-channel detection and delay isolation. Instead of relying on a single mechanical switch that is prone to false triggers, the system uses a “Double Insurance” mechanism. A first channel detects the mechanical insertion, and a second channel verifies the electrical state (like voltage stability or link readiness). Once both conditions are met, the system enforces a delay window (e.g., millisecond-level) to allow mechanical contact bounce and transient electrical jitter to subside before turning on the power or data links. The second component is event-driven power management. Managed by a controller such as a Baseboard Management Controller (BMC), the system can actively respond to a verified insertion by executing a “soft-start”. The controller can gradually ramp up the supply voltage and strictly limits the peak current to prevent inrush surges from crashing adjacent online devices. During a removal event, the controller can prioritize rapid current limiting or power shutdown to prevent arcing and data errors. The third component is proactive zonal thermal pre-conditioning. Instead of waiting for closed-loop temperature sensors to report a heat increase, the insertion event can immediately trigger the cooling system. The cooling system can preemptively increase a cooling capacity (such as a 10%-20% fan speed bump or liquid cooling flow adjustment) strictly in the specific physical zone of the inserted drive, building a pre-cooled environment to suppress thermal spikes. In some cases, a removal event can also trigger the cooling system, e.g., to decrease the cooling capacity in the corresponding physical zone where the hot-swap component is removed. The fourth component is mechanical stabilization structure. The physical housing for the hot-swap component incorporates mounting slots, highly elastic shrapnel, and threaded fixing rods. This structure provides continuous contact pressure to physically dampen mechanical bounce, which synergistically shortens the delay isolation window needed for electrical verification. The fifth component is an optional AI predictive enhancement. The system can integrate an event-triggered AI module (using models like LSTM) that analyzes historical I/O throughput and temperature data. At the exact moment of insertion, the AI can predict the upcoming load trend and feeds this forward to the controller to dynamically scale the exact amplitude of the thermal pre-conditioning and power limits.

Implementations of the present disclosure provide systems and techniques that can address the above-noted limitations of various techniques and realize one or more of the following technical advantages, effects, and/or benefits. For example, firstly, the techniques can achieve enhanced power supply stability and transient shock suppression. Unlike some storage expansion systems that rely on fixed power outputs, the techniques implemented herein use an event-triggered power management protocol. This actively prevents inrush current surges and bus voltage drops that could otherwise destabilize adjacent online devices. During device removal, it prioritizes rapid current limiting or power path shutdown to effectively prevent arcing and data link errors.

Secondly, the techniques can eliminate thermal lag via proactive pre-conditioning. A major advantage of this system is its ability to overcome the inherent thermal lag found in some closed-loop cooling systems. Instead of waiting for a temperature sensor to detect a heat increase after the newly inserted device is fully powered, the controller uses the insertion event itself to trigger proactive thermal pre-conditioning. It preemptively increases cooling capacity strictly in the specific physical zone of the inserted component before its thermal load is fully established. This builds a pre-cooled environment that successfully suppresses severe post-insertion temperature spikes.

Thirdly, the techniques can achieve high reliability against false triggers and mechanical jitter. The system employs a synergistic dual-channel detection and delay isolation mechanism. By requiring simultaneous verification of both mechanical insertion and electrical state stability, and then enforcing a delay window, the system effectively isolates transient mechanical disturbances (like contact bounce, half-insertions, or mechanical jitter) from the electrical control logic. This ensures that system-level actions are only triggered by a verified, stable connection.

Fourthly, the techniques can achieve quantifiable system health and reliability improvements. By actively coordinating power and thermal mitigation, the techniques can drastically improve overall hardware lifespan and system uptime. Performance testing indicates that the system reduces peak over-temperature by 1.5-3 °C, shortens post-insertion system recovery time by 10-20%, increases Mean Time Between Failures (MTBF) by 10-15%, and lowers the emergency shutdown rate by over 30%. Furthermore, the techniques can provide energy savings by eliminating the need to run cooling systems continuously at maximum capacity to handle hot-swaps safely.

Fifthly, the techniques achieve intelligent and adaptive control via AI. With the integration of an optional AI predictive module, the system elevates from a static, rule-based response to an intelligent, adaptive architecture. Operating in an event-triggered mode, the AI can analyze historical data (such as I/O throughput and/or temperature curves) to predict upcoming load trends and temperature rises the exact moment a hot-swap event is detected. This can provide feed-forward parameters that allow the system to dynamically fine-tune the amplitude of the cooling pre-conditioning and power limiting strategies.

Sixthly, the techniques can improve mechanical stability and maintenance efficiency. Physically, the system incorporates an auxiliary connectivity stabilization structure utilizing elastic shrapnel and threaded fixing rods. This structural design provides continuous contact pressure to reduce mechanical contact bounce and improve electrical connection stability during the hot-swap process. Additionally, modular components like a quick-release rear cover enable rapid disassembly and maintenance, lowering operation and maintenance costs.

The described subject matters can be implemented using a computer-implemented method; a non-transitory, computer-readable medium storing computer-readable instructions to perform the computer-implemented method; and a computer-implemented system including one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

“Electronic components” described herein can include, but are not limited to, devices or modules configured to perform computing, storage, communication, or power management functions within a computing device. Such electronic components may be designed to process data, manage memory operations, regulate power distribution, or facilitate input/output operations. Examples of the electronic components can include one or more central processing units (CPUs), one or more graphics processing units (GPUs), or one or more memory units (e.g., dynamic random-access memory (DRAM), static random-access memory (SRAM), non-volatile memory devices such as NVMe drives, or other memory modules). Additional examples include storage devices (e.g., solid-state drives or hard disk drives), network interface controllers (NICs), field-programmable gate arrays (FPGAs), application-specific integrated circuits (ASICs), power management modules, input/output (I/O) controllers, voltage regulators, and accelerators for artificial intelligence or machine learning tasks. For simplicity, the terms “electronic components” and “components” may be used interchangeably to broadly refer to any of those modules described above, integrated within or coupled to a computing device.

“Hot-swap component” can be an electronic component configured to be physically inserted (or plugged) into or removed (or unplugged) from a computing device while the computing device is still running. Examples of a hot-swap component described herein can include, but are not limited to, a Hard Disk Drives (HDD), a Solid State Drives (SSD), a Graphics Processing Units (GPU), a Network Interface Controllers (NIC), a Data Processing Unit (DPU), a Field Programmable Gate Array (FPGA), a CXL memory expander, a PCIe accelerator cards, or any other high-power pluggable module. The hot-swap component can include various form factors and expansion modules, such as: U.2, U.3, E1.S, and E3.S storage modules, PCIe expansion cards, including accelerator cards, and other pluggable modules or pluggable computing or storage units.

In the present disclosure, unless the context clearly dictates otherwise, the terms “coordinate,” “coordinating,” and similar expressions should be given their broadest possible interpretation. These terms generally refer to managing, orchestrating, or otherwise linking a temporal or logical relationship between two or more events, responses, or operations (such as the power control response and the thermal control response) so that they function together effectively. Coordinating the responses can include, for example, synchronizing the responses such that they are executed simultaneously or in strict parallel. However, coordinating is not limited to synchronization; it broadly encompasses sequential execution, partially overlapping execution, or executing actions with a deliberate, predetermined time delay relative to one another or relative to a common trigger (e.g., the insertion event signal).

In the present disclosure, unless the context clearly dictates otherwise, the terms “synchronize,” “synchronizing,” “synchronized,” and similar expressions should be given their broadest possible interpretation. These terms generally refer to coordinating, orchestrating, managing, or otherwise linking a temporal or logical relationship between two or more events, responses, or operations (such as the power control response and the thermal control response). It should be explicitly understood that “synchronize” does not strictly require simultaneous, instantaneous, or strictly parallel execution. While “synchronizing” can include executing operations in parallel, it broadly encompasses sequential execution, partially overlapping execution, or executing actions with a deliberate, predetermined time delay relative to one another or relative to a common trigger (e.g., a movement event signal). For example, synchronizing a power control response and a thermal control response can include initiating the thermal control response immediately prior to, concurrently with, or immediately subsequent to initiating the power control response, so long as both responses are temporally or logically coordinated to safely manage the hot-swap event.

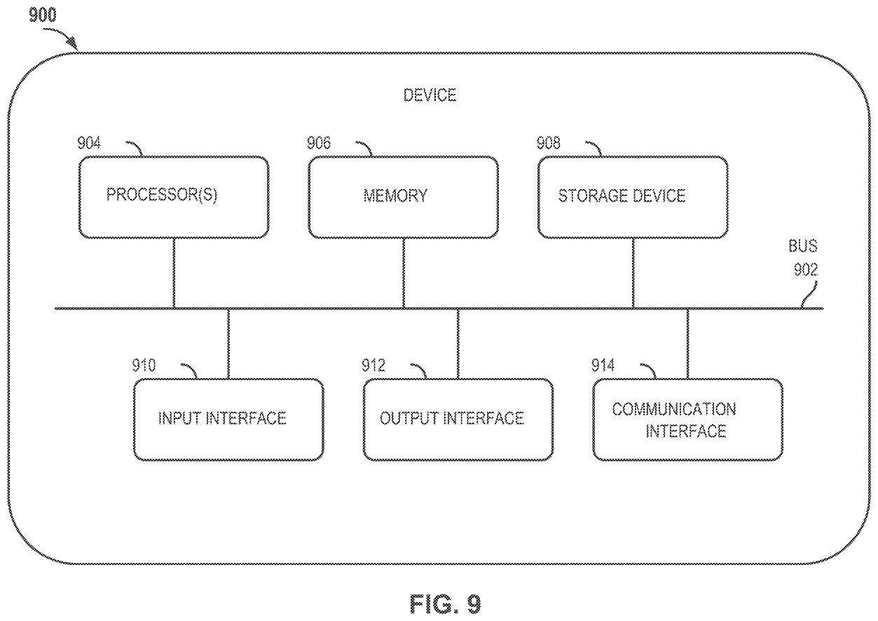

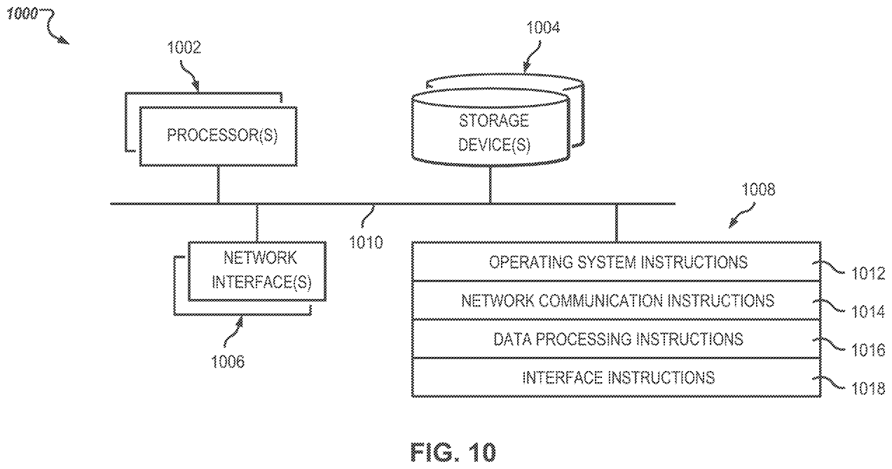

“Computing device(s)” described herein can include one or more computing devices or user devices, such as a server, a personal computer, a laptop, a cellphone, a smart watch, a smart ring, etc. A computing system can include one or more computing units or nodes on a server, or one or more servers coupled to one another via wired or wireless communication. More details of the computing device are described below in connection with FIG. 9, and more details of the computing system are described below in connection with FIG. 10.

In the present disclosure, unless the context clearly dictates otherwise, the terms “controller”, “processor”, and similar expressions should be given their broadest possible interpretation, generally referring to any hardware circuit or device possessing capabilities for logic judgment, numerical calculation, data processing, and/or control signal generation and output. In some examples, such “controller” or “processor” may include, but is not limited to, the following forms or any combination thereof: a central processing unit (CPU), a microprocessor unit (MPU), a microcontroller unit (MCU), a digital signal processor (DSP), a graphics processing unit (GPU), a tensor processing unit (TPU), an application-specific integrated circuit (ASIC), a complex programmable logic device (CPLD), a field-programmable gate array (FPGA), a system-on-chip (SoC), a neural network processing unit (NPU), a data processing unit (DPU), and the like. Furthermore, the “controller” or “processor” referred to in the present disclosure may also be a plurality of independent processing cores or programmable logic units integrated within a single chip package, or a plurality of collaboratively operating processing modules distributed across different physical chips or circuit boards. It should be clearly understood that any specific device mentioned in the present specification is merely an example description provided to facilitate a person of ordinary skill in the art in understanding the technical solution of the present disclosure, and does not constitute any limitation on the protection scope of the present disclosure. When practically implementing the technical solution of the present disclosure, a person of ordinary skill in the art can fully select an appropriate implementation manner or perform equivalent substitutions according to the requirements of specific application scenarios, and all such equivalent implementation manners fall within the protection scope of the present disclosure.

In the present disclosure, unless the context clearly dictates otherwise, the terms “bus”, “power bus”, “power distribution bus”, and similar expressions should be given their broadest possible interpretation, generally referring to the entire power distribution architecture of the computing device or server. For example, such power distribution bus may include a system-level main power bus, and may broadly encompass various levels of power rails distributed across a motherboard, a daughterboard, or a connector circuit, including but not limited to a 48V, 12V, a 5V, or a 3.3V supply rail. The technical effect and objective of the transient power suppression protocol or the power limiting executed by the power control module are to comprehensively suppress, mitigate, or reduce “voltage disturbances” on the power distribution bus or the power rails caused by a hot-swap event. It should be explicitly understood that such “voltage disturbances” are not limited to a bus voltage drop (voltage sagging), but broadly encompass a voltage drop, a voltage overshoot, transient spikes, a voltage ripple, and any electrical instability associated with a physical plugging or unplugging operation. Accordingly, by implementing real-time current monitoring and controlled power limitation, the system can comprehensively manage (e.g., optimize) the transient response of the power distribution bus, preventing the hot-swap perturbation of a localized high-power component from destabilizing or introducing electromagnetic interference to adjacent online hardware devices, thereby ensuring system-level power continuity and stability.

The following detailed description is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as not to obscure one or more described implementations. The present disclosure is not intended to be limited to the described or illustrated implementations, but to be accorded the widest scope consistent with the described principles and features.

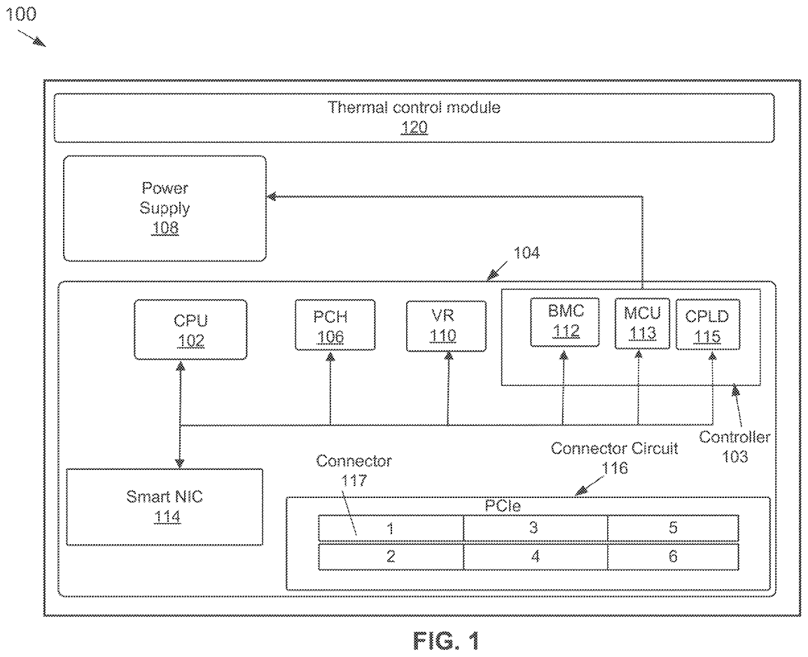

FIG. 1 is a schematic view of an example computing device 100 with hot-swap components. The computing device 100 incorporates a proactive, event-driven, system-level collaborative control architecture that coordinates (e.g., synchronizes) power and thermal responses to safely manage hot-swap operations. By utilizing a mechanical hot-swap event as a trigger source, the computing device 100 departs from some reactive hot-swap models that operate power and cooling subsystems independently and only react after a thermal or electrical disturbance has occurred.

The computing device 100 can include one or more electronic components, such as a processor 102. The processor 102 can be a central processing unit (CPU). The computing device 100 includes a motherboard (MB) 104. The MB 104 can be a main circuit board that connects internal and external components of the computing device 100 and allows them to communicate with one another. One of the one or more electronic components can be a platform controller hub (PCH) 106. The PCH 106 can be mounted on the MB 104 and is configured to manage various input/output (I/O) interfaces on the MB 104 and serve as an intermediary between the processor 102 and peripherals to route data from connected devices.

The computing device 100 can include a power supply 108. The power supply 108 is electrically coupled to the processor 102 through a voltage regulator (VR) 110. In operation, the power supply 108 is configured to supply power to the processor 102, and the VR 110 is configured to regulate the power supplied by the power supply 108 to the processor 102. For example, the VR 110 is configured to maintain a safe operation voltage of the processor 102 during the operation of the computing device 100. The power supply 108 and the VR 110 can operate as, or form a portion of, a power control module configured to regulate a power supply to a target component.

The computing device 100 can include a connector circuit 116 for connecting one or more electronic devices that can be hot-swap components, referred to herein as a target component. The connector circuit 116 can include one or more connectors 117. In some examples, a connector 117 can be a Peripheral Component Interconnect Express (PCIe) connector configured to connect a corresponding PCIe device, such as a graphics processing unit (GPU), a storage device, a sound card, or a network interface controller (NIC). In alternative implementations, the target component can include a U.2 storage module, a U.3 storage module, an E1.S storage module, or an E3.S storage module.

In some implementations, the computing device 100 can include a Smart NIC 114. The Smart NIC 114 can be mounted on the MB 104. The connector circuit 116 is electrically or communicatively coupled to the processor 102 and the Smart NIC 114. In some implementations, the Smart NIC 114 can be configured to control the PCIe devices and enable the computing device 100 to communicate with other devices on a network.

The connector circuit 116 and the corresponding connectors 117 can act as a physical interface containing a hot-swap detection module configured to detect a physical insertion of the target component into the computing device 100 or a physical removal of the target component from the computing from 100 and generate an insertion event signal or a removal event signal. The hot-swap detection module utilizes a dual-channel detection mechanism, including a first channel configured to detect a mechanical state of the target component and a second channel configured to detect an electrical state of the target component.

The computing device 100 can include a controller 103 communicatively coupled to the connector circuit 116, the power supply 108, and a thermal control module 120. The controller 103 can act as a central logic unit configured to receive the insertion event signal or the removal event signal from the hot-swap detection module and coordinate (e.g., simultaneously generate) a power control response and a thermal control response. The controller 103 can include a Baseboard Management Controller (BMC) 112, a microcontroller unit (MCU) 113, and a complex programmable logic device (CPLD) 115 mounted onto the MB 104. In some implementations, the BMC 112 provides out-of-band management of the computing device 100, while the CPLD 115 includes programmable logic blocks freely programmed by the processor 102. In alternative implementations, the functions of the controller 103 can be distributed across the BMC 112, the MCU 113, and the CPLD 115, or handled entirely by an integrated System-on-Chip (SoC).

In operation, the controller 103 is configured to register the insertion event signal only when both the first channel and the second channel of the hot-swap detection module satisfy preset conditions simultaneously. To isolate the controller 103 from transient mechanical contact bounce, the controller 103 can enforce a preset delay isolation window (e.g., millisecond level) after the first channel detects the mechanical state and prior to executing a transient power suppression protocol. This multi-layered verification provides a technical advantage by effectively isolating transient mechanical disturbances from the electrical control logic, ensuring system-level actions are only triggered by a verified, stable connection.

In contrast to an insertion event that requires both the first channel and the second channel to satisfy preset conditions simultaneously, the controller 103 can be configured to register a removal event signal if either the first channel or the second channel fails to satisfy a preset condition. In some implementations, to ensure safe decoupling, the hot-swap detection module can be configured to provide a pre-removal warning to the controller 103 based on an early, asynchronous trigger. For example, the first channel can detect a mechanical state change—such as a mechanical latch release or a disengagement of a specifically shortened presence detect pin—strictly before the target component is physically pulled from the connector and loses its main electrical contact. Upon registering this early mechanical trigger as the removal event signal, the controller immediately commands the power control module to prioritize rapid current limiting or a power path shutdown, and gracefully severs data links. This graceful degradation provides the technical advantage of fully powering down the target component prior to the physical disconnection of the main electrical pins, thereby actively preventing electrical arcing, bus voltage fluctuations, and data link errors during a live removal.

In some implementations, in response to receiving the verified insertion event signal, the controller 103 can coordinate (e.g., synchronize) the power control response and the thermal control response. The controller 103 can command the power control module (e.g., via the power supply 108) to execute the transient power suppression protocol, which includes ramping up a supply voltage of the power supply 108 to the target component. For example, the transient power suppression protocol can include a soft-start sequence that ramps up the supply voltage according to a predetermined slope via a power path, while monitoring real-time current and enforcing a strict peak current limit, e.g., to prevent bus voltage drops.

Meanwhile, the controller 103 can command the thermal control module 120 to execute a thermal pre-conditioning protocol. The thermal control module 120 is configured to regulate a cooling capacity of a physical zone corresponding to the target component. The thermal pre-conditioning protocol can include increasing the cooling capacity of the physical zone based on the insertion event signal and prior to the supply voltage to the target component being fully established by the transient power suppression protocol. The integration of the controller 103, the connector circuit 116, and the thermal control module 120 provides the technical advantage of building a pre-cooled environment to suppress transient current shocks and prevent localized heat mutations before the thermal load of a newly inserted target component is fully established.

The computing device 100 can further include a predictive module operating within or coupled to the controller 103 in an event-triggered mode. The predictive module can receive an event signal (e.g., the insertion event signal or the removal event signal), analyze historical operating data (e.g., historical temperature curves or I/O throughput), and predict a load trend and a temperature rise or fall of the target component. The predictive module provides a feed-forward parameter to the controller 103 to dynamically adjust an amplitude of the thermal pre-conditioning protocol and a power limiting threshold of the transient power suppression protocol, providing the technical advantage of elevating the computing device 100 from a static, rule-based response to an intelligent, adaptive response.

The predictive module can be implemented in various configurations within or communicatively coupled to the computing device 100. In some implementations, the predictive module is an integrated artificial intelligence module embedded directly within the controller 103. For example, the predictive module can be implemented as firmware or software instructions stored in memory and executed by the Baseboard Management Controller (BMC) 112 or the microcontroller unit (MCU) 113. Alternatively, the predictive module can be executed by the main processor 102 or by a dedicated artificial intelligence accelerator coupled to the motherboard (MB) 104. In yet other implementations, the predictive module can operate within a federated learning architecture. Under this architecture, the predictive module can be configured to locally train a prediction model on the computing device 100 and upload model weights to a central coordinating node—such as a data center management server—without sharing raw historical operating data, thereby improving cross-environment adaptability. This flexible deployment provides the technical advantage of enabling localized, low-latency feed-forward adjustments while simultaneously allowing for scalable, privacy-preserving machine learning across multiple computing devices.

It should be explicitly understood that the techniques disclosed herein lies in an “Event-driven Coordinated Control Architecture”. This architecture is based on system-level global coordination and optimization, aiming to treat a hot-swap event as a unified trigger source to comprehensively suppress, manage, or reduce the electrical, thermal, and logical disturbances caused by the hot-swap event on the “entire system,” rather than being limited to protecting or targeting a single specific hardware component. In some cases, the technical effects and objectives achieved by the system-level coordinated control architecture of the present disclosure can include: (1) significantly reducing the probability of misjudgments by a controller (including, but not limited to, a Baseboard Management Controller (BMC), a Microcontroller Unit (MCU), and a Complex Programmable Logic Device (CPLD)) caused by physical contact bounce, transient noise, or localized voltage drops, thereby substantially improving the reliability of event determination and control triggering; (2) comprehensively improving the global power supply stability of a System Power Bus or various levels of Power Rails, ensuring their transient response and voltage accuracy; (3) effectively preventing abnormal power-on, abnormal current shocks, or arcing phenomena of the hot-swappable target component during physical insertion or unsteady contact; and/or (4) minimizing the adverse impacts brought by the hot-swap event on the power quality, data links, and global system operations of other online devices currently running in the system, ensuring business continuity in high-density server environments. Therefore, all descriptions herein regarding detection channels, delay isolation, power management, and thermal pre-conditioning should be viewed as integral components and means within this system-level coordinated control architecture, and their specific component configurations do not constitute any limitation on the global protection scope of the present disclosure.

In some implementations, the system-level collaborative control architecture can be scaled to encompass a rack-level, a cluster-level, or a data-center-level coordinated control. For example, in a high-density artificial intelligence (AI) server deployment, multiple computing devices can be housed within a single rack or interconnected across a computing cluster. A rack-level controller, a cluster-level management node, or the management system (e.g., the data center Building Management System (BMS)) can be configured to aggregate the insertion event signals, the predictive telemetry, and the real-time operating data from the multiple computing devices. Based on this aggregated data, the management system can execute the coordinated control by dynamically distributing power budgets and shared cooling resources—such as facility-level liquid cooling loops or computer room air conditioning (CRAC) units—across the rack, the cluster, or the data center. Incorporating rack-level, cluster-level, or data-center-level coordinated control provides the technical advantage of preventing localized thermal hotspots and facility-level power overloads, thereby ensuring continuous operational stability and optimizing global energy efficiency for large-scale, high-density AI deployments.

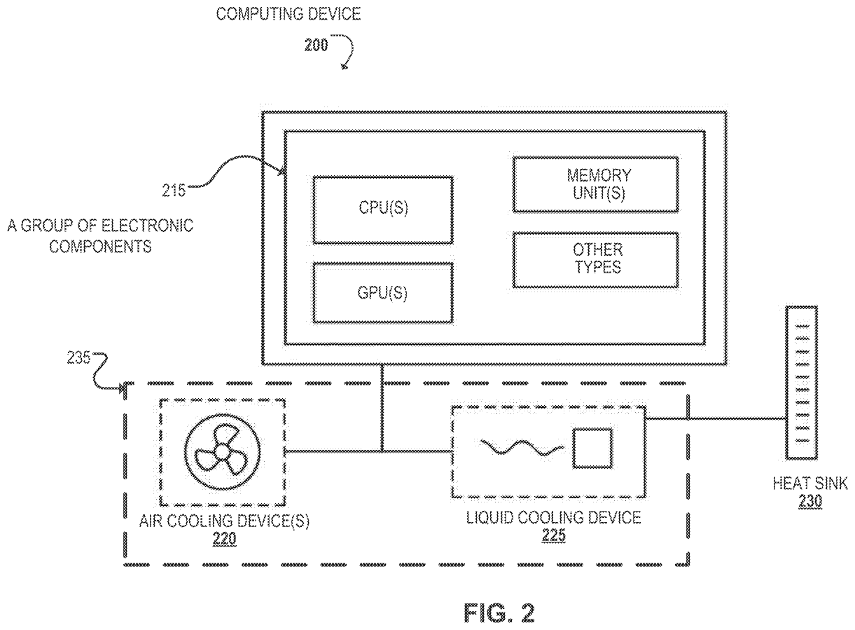

FIG. 2 is a schematic diagram of an example of a computing device 200 with a cooling module 235. The computing device 200 described herein can be the same as, or similar to, the computing device 100 of FIG. 1. Furthermore, the cooling module 235 can be an example of the thermal control module 120 of FIG. 1.

As shown in FIG. 2, the computing device 200 includes a group of electronic components 215. The group of electronic components 215 may include one or more central processing units (CPUs), graphics processing units (GPUs), tensor processing units (TPUs), memory units, or other types of heat-generating components commonly found in high-performance computing systems. At least one component of the group of electronic components 215 can be a hot-swapping component, referred to herein as a target component, e.g., a PCIe GPU, an NIC/DPU, a FPGA, a CXL memory expander, a PCIe accelerator card, a SSD/HDD, or any other high-power pluggable module. To maintain an appropriate operating temperature, the group of electronic components 215 is thermally paired with the cooling module 235.

The cooling module 235 can include one or more air cooling devices 220, such as fans, and a liquid cooling device 225. The one or more air cooling devices 220 provide forced-air cooling by circulating air around the group of electronic components 215, while the liquid cooling device 225 provides more direct and efficient heat removal. The liquid cooling device 225 can include a liquid pump that circulates a coolant, such as water or a refrigerant, through a network of tubes or pipes. As the coolant flows, it absorbs heat from the group of electronic components 215 and carries it away from the group of electronic components 215.

In some implementations, the liquid cooling device 225 may include a cold plate positioned directly on top of, or beneath, some heat-generating electronic components, such as GPUs or TPUs, to improve thermal efficiency. Tubes or pipes of the liquid cooling device 225 may be arranged to make contact with or pass through a heat sink 230, which further dissipates the absorbed heat from the coolant into the surrounding air. This combined structure of the cooling module 235 with various types of cooling devices, such as the one or more air cooling devices 220 and the liquid cooling device 225, alongside the heat sink 230, allows the system to effectively manage the ambient temperatures of the group of electronic components 215.

To facilitate highly targeted thermal management, a physical space within the computing device 200 around the group of electronic components 215 is divided into multiple physical zones. The cooling module 235 is configured to regulate a cooling capacity of a specific physical zone corresponding to the target component. When the target component is inserted, a controller (e.g., the controller 103 of FIG. 1) commands the cooling module 235 to selectively increase the cooling capacity strictly in the physical zone corresponding to the newly inserted target component. This zonal targeting provides the technical advantage of directing thermal mitigation resources precisely where a heat load mutation will occur, optimizing energy efficiency while preventing thermal bleed to adjacent online devices.

Conventional reactive cooling systems inherently suffer from thermal lag because they rely on closed-loop temperature sensors that only detect a heat increase after a newly inserted device is fully powered and operating. To overcome this limitation, the cooling module 235 is configured to execute a thermal pre-conditioning protocol. The controller commands the cooling module 235 to execute this thermal pre-conditioning protocol based on a received insertion event signal, preemptively increasing the cooling capacity of the physical zone prior to a supply voltage to the target component being fully established.

Executing the thermal pre-conditioning protocol involves proactively adjusting the active cooling hardware. For example, increasing the cooling capacity can include preemptively increasing a fan pulse-width modulation (PWM) duty cycle of the one or more air cooling devices 220 by a percentage, such as 10% to 20%, or adjusting a liquid cooling flow rate of the liquid cooling device 225. This preemptive action provides the technical advantage of creating a “pre-cooled environment” ahead of the actual heat load mutation. By building this pre-cooled environment, the cooling module 235 actively suppresses localized transient temperature spikes that plague high-density data centers, thereby extending component lifespan and increasing a Mean Time Between Failures (MTBF) of the computing device 200.

Following the completion of the hot-swap event and the stabilization of the target component, the controller is configured to transition the cooling module 235 from the event-driven thermal pre-conditioning protocol to a reactive closed-loop proportional-integral-derivative (PID) control. This handoff relies on real-time temperature sensor data to continuously maintain an operating temperature. Transitioning to the closed-loop PID control provides the technical advantage of smoothly handing off the proactive transient mitigation phase back to a highly accurate, steady-state thermal monitoring phase, preserving energy once the initial thermal shock has been suppressed.

The cooling module 235 is additionally configured to respond to critical errors during a hot-swap operation by entering a protective state. The controller monitors for anomaly conditions, which can include a rapid over-temperature, a severe voltage drop, or a half-insertion fault of the target component. In response to detecting an anomaly condition, the controller triggers a safe mode that forces the cooling module 235 to a full cooling capacity and transmits a maintenance alert. Forcing the full cooling capacity may include commanding the one or more air cooling devices 220 to operate at 100% rotations per minute (RPM) and maximizing a liquid flow rate of the liquid cooling device 225. Triggering the safe mode provides the technical advantage of immediately mitigating severe thermal risks and preventing system-level fault propagation, thereby safeguarding the structural integrity of the computing device 200 under edge-case failure scenarios.

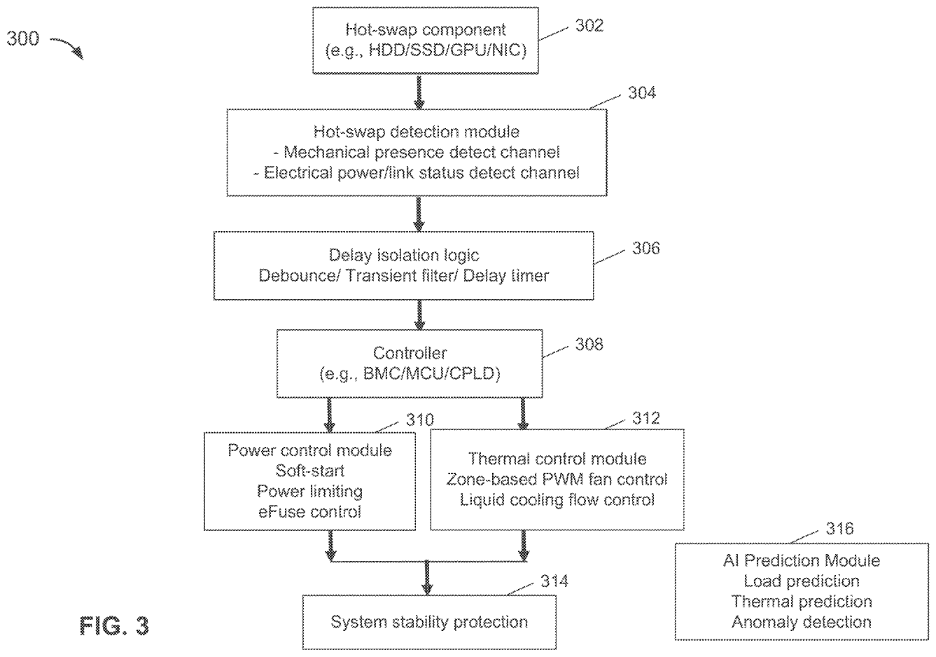

As described in further detail with reference to FIGS. 3-7, a computing device (e.g., the computing device 100 of FIG. 1 or the computing device 200 of FIG. 2) can be configured to implement a hot-swap event-driven control architecture. This architecture can safely handle hot-swap operations by preemptively managing both power and thermal loads, thereby facilitating uninterrupted system uptime and preserving hardware lifespan.

FIG. 3 illustrates an example hot-swap event based control architecture 300 in the computing device. The control architecture 300 enables a proactive, event-driven data flow that departs from some reactive hot-swap models by synchronizing power and thermal responses across a system level.

As shown in FIG. 3, the computing device can include a hot-swap component 302, also referred to herein as a target component, that can include a hard disk drive (HDD), a solid-state drive (SSD), a graphics processing unit (GPU), a network interface controller (NIC), a DPU, a FPGA, a CXL memory expander, a PCIe accelerator card, or any other high-power pluggable module.

The control architecture 300 can include a hot-swap detection module 304 that can be physically implemented in a connector such as the connector 117 of FIG. 1 or a connector circuit such as the connector circuit 116 of FIG. 1. The hot-swap detection module 304 can implement a dual-channel detection mechanism to reliably identify the insertion or removal of the hot-swap component 302. In some implementations, the hot-swap detection module 304 includes a mechanical presence detect channel configured to detect a mechanical state of the target component, and an electrical power or link status detect channel configured to detect an electrical state of the target component. The control architecture 300 dictates that a valid insertion event signal is registered only when both the mechanical presence detect channel and the electrical power or link status detect channel satisfy preset conditions simultaneously.

In contrast to an insertion event that requires both the first channel and the second channel to satisfy preset conditions simultaneously, the control architecture 300 can be configured to register a removal event signal if either the first channel or the second channel fails to satisfy a preset condition. In some implementations, for a removal event, the hot-swap detection module 304 can be configured to provide a pre-removal warning to the controller. For example, the first channel can detect a mechanical latch release before the target component is physically pulled from the connector. In response to this pre-removal warning, the power control module 310 can be configured to prioritize rapid current limiting or power path shutdown, and gracefully sever data links, strictly prior to the physical disconnection of the target component's pins. This graceful degradation provides the technical advantage of preventing electrical arcing and data link errors during live removal.

In some implementations, the electrical power or link status detect channel (e.g., the second channel of the hot-swap detection module) is configured to verify the electrical state of the target component by monitoring one or more specific electrical parameters and signal conditions. For example, the electrical power or link status detect channel can detect whether a power supply voltage to the target component is stable. This voltage stability verification can include determining whether specific power rails, such as a 5 V or 3.3 V supply, are properly established, which can be monitored via a “power good” signal. Additionally, the electrical power or link status detect channel can be configured to monitor current changes, overall current stability, or changes in contact resistance to ensure a solid electrical connection has been formed. Beyond power metrics, the electrical power or link status detect channel can evaluate signal stability to verify a data link status or a link readiness of the target component, thereby ensuring the target component is fully ready to communicate with a system bus. Furthermore, in some structural implementations, a mechanical housing configured to receive the target component can include highly elastic shrapnel or a threaded fixing rod that provides a preliminary electrical function, such as serving as an early ground or an electrostatic discharge path, to aid the electrical power or link status detect channel in performing the electrical verification.

To further ensure signal validity, the hot-swap detection module 304 can route detection signals through a delay isolation logic 306. The delay isolation logic 306 can include at least one of a debounce mechanism, a transient filter, or a delay timer. In operation, the delay isolation logic 306 can enforce a preset (e.g., millisecond-level) delay isolation window after the mechanical presence detect channel detects the mechanical state. The preset delay isolation window can be dynamically adjusted based on a state stable judgment that continuously evaluates a real-time voltage and a signal stability. The delay isolation logic 306 can provide the technical advantage of isolating downstream components from transient mechanical contact bounce and transient electrical jitter, thereby preventing false event triggers and ensuring that system-level actions are only initiated by a verified, stable connection.

In some implementations, to achieve the millisecond-level responsiveness required for the hot-swap event-driven control, the controller samples the real-time operating data at high frequencies. For example, the controller can sample analog current and voltage data via an analog-to-digital converter (ADC) at a sampling frequency ranging from 1 kHz to 10 kHz. Furthermore, when acquiring data via the I2C interface, the communication bus can operate at a frequency ranging between 100 kHz and 400 kHz, or up to 1 MHz for high-performance applications, ensuring that transient electrical jitter and thermal spikes are detected virtually instantaneously.

In some implementations, during the preset delay isolation window or immediately upon verifying the electrical state, the controller can be configured to identify a device type or a power profile of the target component. For example, the controller can distinguish between a standard storage drive and a high-draw PCIe expansion card. Based on the identified device type or power profile, the controller can dynamically scale the predetermined slope (e.g., dv/dt control) of the supply voltage during the soft-start sequence. Furthermore, the controller can dynamically scale an amplitude of the thermal pre-conditioning protocol, such as determining whether to preemptively increase the cooling capacity by 10% or 30%, based on the specific power profile of the target component.

After the delay isolation logic 306 verifies the event, an insertion event signal is transmitted to a controller 308. The controller 308 can be physically implemented as the controller 103 of FIG. 1, which may include the Baseboard Management Controller (BMC) 112, the microcontroller unit (MCU) 113, and/or the complex programmable logic device (CPLD) 115. The controller 308 acts as the central logic unit for the control architecture 300. In response to receiving the insertion event signal, the controller 308 can manage a power control response and a thermal control response to mitigate system-level disturbances caused by the hot-swap event. In some cases, the controller can coordinate the power control response and the thermal control response by issuing parallel commands to a power control module 310 and a thermal control module 312.

The power control module 310 can be physically implemented via the power supply 108 and the voltage regulator 110 of FIG. 1. In response to commands from the controller 308, the power control module 310 can execute a transient power suppression protocol. This protocol includes a soft-start sequence that ramps up a supply voltage to the hot-swap component 302 according to a predetermined slope via a power path (e.g., including eFuse control or MOSFETs). Additionally, the power control module 310 can be configured to execute power limiting by monitoring real-time current and enforcing a peak current limit during the soft-start sequence. Executing the transient power suppression protocol can provide the technical advantage of preventing bus voltage drops and suppressing transient current shocks (inrush surges) that could destabilize adjacent online devices.

During the soft-start and power limiting sequences, the power control module dynamically regulates the specific voltage and current delivery based on the profile of the target component. For example, if the target component requires a 10W power supply, the power control module can enforce the peak current limit by configuring the power path to safely deliver 1V at 10A, 2V at 5A, or 10V at 1A, depending on the specific electrical requirements and the predetermined slope of the soft-start sequence.

Simultaneously, the thermal control module 312 can be configured to respond to the controller 308 by executing a thermal pre-conditioning protocol. The thermal control module 312 can be physically implemented as the thermal control module 120 of FIG. 1 and the cooling module 235 of FIG. 2, utilizing the air cooling device 220 and the liquid cooling device 225. The thermal pre-conditioning protocol can include executing zone-based pulse-width modulation (PWM) fan control or liquid cooling flow control to increase a cooling capacity in a physical zone corresponding to the hot-swap component 302. The thermal control module 312 can preemptively increase this cooling capacity based on the insertion event signal and prior to the supply voltage to the hot-swap component 302 being fully established by the power control module 310. This synchronization provides the technical advantage of structurally overcoming inherent thermal lag by building a pre-cooled environment ahead of an actual heat load mutation, actively suppressing transient temperature spikes.

In implementations utilizing liquid cooling, the thermal pre-conditioning protocol can dynamically adjust parameters within a Coolant Distribution Unit (CDU) or a liquid cooling loop. Increasing the cooling capacity can include adjusting a liquid cooling flow rate by preemptively increasing a pump flow rate. Additionally, the controller can preemptively adjust valve positions within the CDU to route increased coolant flow specifically to a cold plate loop corresponding to the physical zone of the inserted target component. This localized fluid routing structurally overcomes the mechanical response time of the fluid system prior to full thermal load establishment.

The outputs and operational states of the power control module 310 and the thermal control module 312 can converge to ensure system stability protection 314. The system stability protection 314 includes a safe mode configured to handle anomaly conditions during the hot-swap process, such as a rapid over-temperature, a severe voltage drop, or a half-insertion fault. In response to detecting an anomaly condition, the controller 308 triggers the safe mode, which forces the thermal control module 312 to a full cooling capacity, reduces a power output limit of the power control module 310, and transmits a maintenance alert. This provides the technical advantage of immediately containing hardware faults and safeguarding the computing device from cascading electrical or thermal damage.

In some implementations, in response to detecting an anomaly condition, such as a rapid over-temperature, a severe voltage drop, a fan failure, or a half-insertion fault, the controller triggers a safe mode to prevent system-level fault propagation. Triggering the safe mode forces the thermal control module 312 to a full cooling capacity and reduces a power output limit of the power control module 310. Furthermore, entering the safe mode can include actively limiting overall system performance, such as executing CPU or GPU compute throttling, to immediately reduce thermal pressure on the computing device. The controller can simultaneously transmit a maintenance alert to a management system to notify administrators of the anomaly.

In some implementations, the thermal control module 312 includes a plurality of fans distributed across the physical zone. In response to detecting a failure of a single fan among the plurality of fans, the controller can be configured to automatically execute a redundancy compensation protocol. Executing the redundancy compensation protocol can include dynamically increasing a speed (e.g., the PWM duty cycle) of adjacent fans within the physical zone to compensate for the failed fan, thereby maintaining an overall cooling efficiency and preventing localized overheating without necessarily triggering a full system safe mode.

In some implementations, the target component can include a composite module containing multiple sub-units. In such scenarios, the insertion event signal can comprise a connection status between the target component and the computing device indicating the specific operational states of the multiple units within the target component. The controller can be configured to generate the power control response and the thermal control response based on this granular connection status. By evaluating which specific units are active or inactive, the controller can dynamically adjust a power output and a cooling capability directed at the target component to save power for the inactive units, optimizing overall energy efficiency.

In some implementations, the control architecture 300 further includes an AI prediction module 316 configured to operate in an event-triggered mode. The AI prediction module 316 can be implemented as firmware or hardware accelerators within or coupled to the controller 308. Upon receiving the insertion event signal, the AI prediction module 316 can analyze historical operating data, which can include a CPU/GPU utilization rate, a hard disk I/O throughput, a chassis inlet temperature, or a historical temperature curve. Using a machine learning model—such as a Long Short-Term Memory (LSTM) model, a K-Nearest Neighbors (KNN) model, a Random Forest model, a Neural Network, or an Isolation Forest model—the AI prediction module 316 can generate at least one of a load prediction, a thermal prediction, or anomaly detection data associated with the target component. The AI prediction module 316 can then provide a feed-forward parameter to the controller 308 to dynamically adjust an amplitude of the thermal pre-conditioning protocol and/or a power limiting threshold of the transient power suppression protocol. The integration of the AI prediction module 316 provides the technical advantage of elevating the control architecture 300 from a static, rule-based response to an intelligent, adaptive response that dynamically scales mitigation efforts to the specific device type being inserted, thereby optimizing energy efficiency.

In some implementations, the AI predictive module 316 can be further configured to utilize telemetry history and event logging to perform comprehensive health monitoring and failure prediction. For example, the historical operating data analyzed by the predictive module can further include telemetry history, which captures continuous time-series data of system diagnostics and component performance, and event logging, which records discrete system events, error codes, and maintenance flags over time. By continuously analyzing the telemetry history and the event logging, the AI predictive module 316 can execute health monitoring to track a real-time operational status and a potential degradation of specific hardware components, such as the power control module, the thermal control module, or the target component itself. Furthermore, the AI predictive module 316 can perform failure prediction by identifying anomalous patterns, statistical outliers, or long-term degradation trends within the telemetry history. This capability allows the controller to preemptively generate targeted maintenance alerts or initiate protective protocols before a critical hardware failure occurs. Incorporating telemetry history, event logging, health monitoring, and failure prediction provides the technical advantage of significantly enhancing system reliability and reducing unplanned downtime by shifting maintenance strategies from reactive responses to predictive, data-driven interventions.

When evaluating the statistical outliers in the operational data, the AI prediction module 316 can calculate a real-time anomaly score for the target component or the cooling module. If the calculated anomaly score exceeds a predefined threshold, such as a 95th percentile threshold, the AI prediction module 316 determines that a failure is imminent. In response to the anomaly score exceeding the 95th percentile threshold, the controller preemptively triggers the safe mode, thereby immediately lowering the fault risk and preventing system-level hardware failure.

In some implementations, the controller is configured to communicate with a management system, such as a data center Building Management System (BMS), to facilitate global energy scheduling. The controller can communicate with the management system via a standard communication protocol, which can include at least one of Intelligent Platform Management Interface (IPMI), Redfish, Simple Network Management Protocol (SNMP), Modbus, or BACnet. During operation, including a hot-swap event, the controller can upload transient current data, temperature changes, fan speeds, and power consumption data to the management system. In response to a simultaneous mass hot-swap event across multiple computing devices, the controller can receive a global energy scheduling command from the management system. This scheduling command can enforce a staggered power-on delay for specific devices or dynamically adjust a global power-limiting threshold to optimize energy distribution and prevent facility-wide overloads.

In some implementations, to facilitate closed-loop monitoring and anomaly detection, the controller can be configured to acquire real-time operating data from various hardware interfaces. The real-time operating data can include fan speed data acquired via a TACH signal (speed feedback) outputted by a fan controller or the fan itself. Additionally, the real-time operating data can include temperature data acquired via an I2C interface sensor located in proximity to the target component or key physical zones. The real-time operating data can further comprise current data, voltage data, or voltage ripple data acquired via a power monitoring chip (e.g., an INA series integrated circuit) utilizing an I2C or PMBus interface.

When acquiring the real-time operating data, the controller can sample the voltage ripple data to continuously evaluate and judge the stability of the power supply during the hot-swap event. By analyzing the voltage ripple data via an analog-to-digital converter (ADC) or a power monitoring integrated circuit, the controller can precisely detect transient voltage anomalies that may not trigger standard over-voltage or under-voltage thresholds.

The physical zones regulated by the thermal control module can be configured with flexible cooling arrangements based on the specific system architecture. For example, the thermal control module can be configured such that a single air cooling device (e.g., one fan) corresponds to and cools multiple target components (e.g., a cluster of storage modules). Conversely, the thermal control module can be configured such that multiple air cooling devices correspond to a single high-power region, such as a physical zone containing a single, high-draw graphics processing unit (GPU).

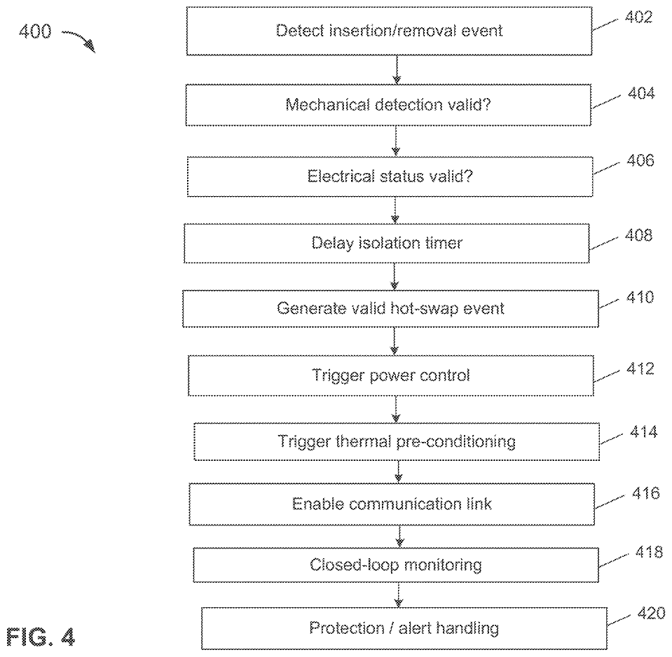

FIG. 4 is a flow chart of a process 400 for a hot-swap event based control method. The process 400 illustrates an operational control flow that departs from some reactive hot-swap methods by implementing a proactive, event-driven, and system-level collaborative control architecture. By sequentially validating an insertion or removal event and subsequently synchronizing power and thermal mitigation protocols, the process 400 provides the technical advantage of mitigating power and thermal disturbances before a full load is established on a computing device, thereby facilitating uninterrupted system uptime and preserving hardware lifespan. The process 400 can be executed by a controller, such as the controller 103 of FIG. 1 or the controller 308 of FIG. 3, operating in conjunction with associated hardware subsystems in th computing device.

The process 400 begins at step 402, where the computing device detects a physical insertion or removal event of a target component. This detection is executed via a hot-swap detection module, such as the hot-swap detection module 304 integrated into the connector circuit 116 or the connectors 117 of FIG. 1. Following the initial detection, the process 400 initiates a dual-channel verification sequence to ensure the validity of the event. At step 404, the computing device determines whether a mechanical detection is valid by verifying a mechanical state of the target component via a first channel (e.g., checking a presence switch or detect pin). Simultaneously or sequentially, at step 406, the computing device determines whether an electrical status is valid by verifying an electrical state of the target component via a second channel (e.g., verifying voltage stability or a power-good signal). The computing device can be configured to proceed only when both the first channel and the second channel satisfy preset conditions simultaneously, providing the technical advantage of preventing false triggers caused by half-insertions or mechanical jitter.

If both the mechanical state and the electrical state are valid, the process 400 advances to step 408 to initiate a delay isolation timer. Executing step 408 can include enforcing a preset (e.g., millisecond-level) delay isolation window after the first channel detects the mechanical state and prior to generating a finalized event signal. Implementing the delay isolation timer at step 408 can provide the critical technical advantage of isolating the controller from transient mechanical contact bounce and electrical jitter, ensuring that subsequent power and data link enablements are only triggered by a verified, stable physical connection.

Following the expiration of the delay isolation window, the process 400 proceeds to step 410 to generate a valid hot-swap event signal. Generating the valid hot-swap event signal actively triggers downstream mitigation responses. Furthermore, at step 410, generating the event signal can trigger a predictive module (such as the AI prediction module 316 of FIG. 3) operating in an event-triggered mode. The predictive module can receive the insertion event signal, analyze historical operating data, and predict a load trend and a temperature rise of the target component. Using this prediction, the predictive module provides a feed-forward parameter to the controller to dynamically adjust the amplitude of the subsequent power and thermal control responses, offering the technical advantage of elevating the process 400 into an intelligent, adaptive operation that optimally scales resource allocation.

In response to generating the valid hot-swap event at step 410, the process 400 branches into synchronized, parallel mitigation actions at step 412 and step 414. At step 412, the controller commands a power control module (e.g., the power supply 108 and the VR 110 of FIG. 1, or the power control module 310 of FIG. 3) to trigger power control. Triggering power control includes executing a transient power suppression protocol, which involves ramping up a supply voltage to the target component according to a predetermined slope (a soft-start) while enforcing a strict peak current limit. Executing step 412 provides the technical advantage of suppressing inrush currents and preventing bus voltage drops that could otherwise destabilize the computing device.

Synchronized with the power control, at step 414, the controller commands a thermal control module (e.g., the thermal control module 120 of FIG. 1, or the cooling module 235 of FIG. 2) to trigger thermal pre-conditioning. In some implementations, triggering thermal pre-conditioning includes executing a thermal pre-conditioning protocol by increasing a cooling capacity of a physical zone associated with the target component. Crucially, the controller initiates this increase in cooling capacity prior to the supply voltage being fully established at step 412. Triggering thermal pre-conditioning at step 414 can provide the significant technical advantage of building a pre-cooled environment ahead of the target component's heat load mutation, structurally overcoming the thermal lag inherent in conventional systems and actively suppressing transient temperature spikes.

Once the transient power and thermal suppressions are actively managing the hot-swap shock, the process 400 advances to step 416 to enable a communication link. Enabling the communication link securely bridges the target component's data lines to the motherboard bus (e.g., via the Smart NIC 114 of FIG. 1). After the target component reaches a steady state, the process 400 transitions to step 418 for closed-loop monitoring. At step 418, the controller transitions the thermal control module from the proactive thermal pre-conditioning protocol back to a reactive closed-loop proportional-integral-derivative (PID) control based on real-time temperature sensor data. This transition provides the technical advantage of smoothly handing off system control to a highly accurate, steady-state monitoring phase that optimizes ongoing energy consumption.

While transitioning to the reactive closed-loop control can utilize a proportional-integral-derivative (PID) algorithm to maintain voltage regulation accuracy and temperature stability, the controller can also utilize alternative control algorithms. These alternative control algorithms can include a lookup table control, a fuzzy logic control, or a rule-based control algorithm. The controller can utilize these algorithms to dynamically adjust the power output and the cooling capacity based on the real-time sensor data.

During the closed-loop monitoring phase, the controller continuously compares the real-time operating data (e.g., voltage, current, and temperature) against target setpoints. By utilizing the proportional-integral-derivative (PID) algorithm to dynamically adjust the power output and the fan speed, the controller can maintain a strict voltage regulation accuracy of ±2%. Maintaining this ±2% voltage regulation accuracy provides the technical advantage of ensuring highly efficient, low-power operation without causing electrical instability to the target component.

Finally, during continuous operation, the process 400 incorporates step 420 for protection and alert handling. Step 420 can be implemented via the system stability protection 314 block of FIG. 3. If the controller detects an anomaly condition—such as a rapid over-temperature, a severe voltage drop, or a half-insertion fault—the controller triggers a safe mode. Activating the safe mode can include forcing the thermal control module to a full cooling capacity, reducing a power output limit of the power control module, and transmitting a maintenance alert. Incorporating step 420 in the process 400 can provide the technical advantage of immediately containing critical hardware faults, averting system-wide failure, and ensuring long-term operational reliability for the computing device.

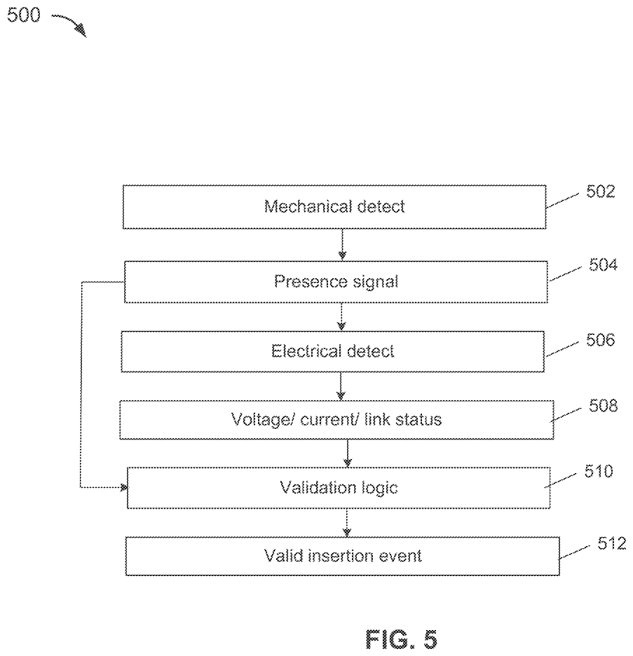

FIG. 5 illustrates an example dual-channel detection mechanism 500 in a computing device. The dual-channel detection mechanism 500 can implement a proactive verification process to reliably identify a hot-swap event. Some hot-swap systems rely on a single mechanical switch to detect a component insertion, which leaves such systems vulnerable to false triggers, half-insertions, and arcing. In contrast, the dual-channel detection mechanism 500 provides the technical advantage of a “Double Insurance” verification that ensures subsequent high-power enablement is completely safe and stable by requiring both physical and electrical validation.

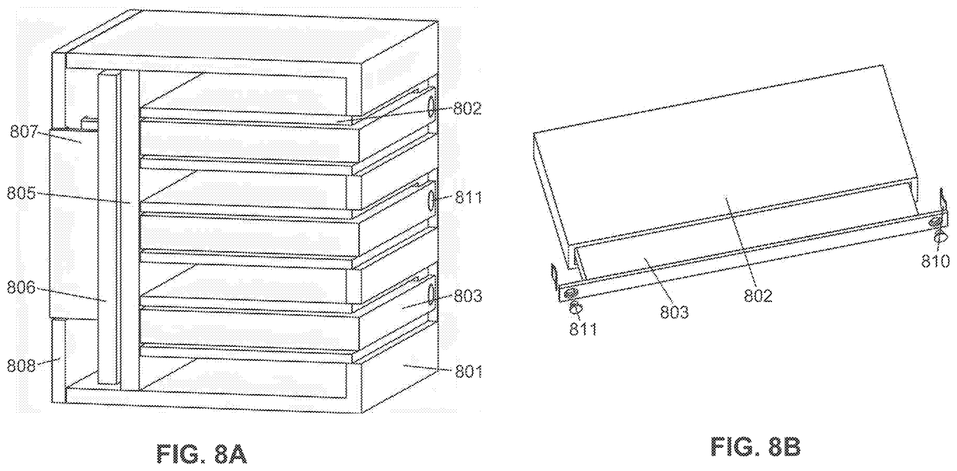

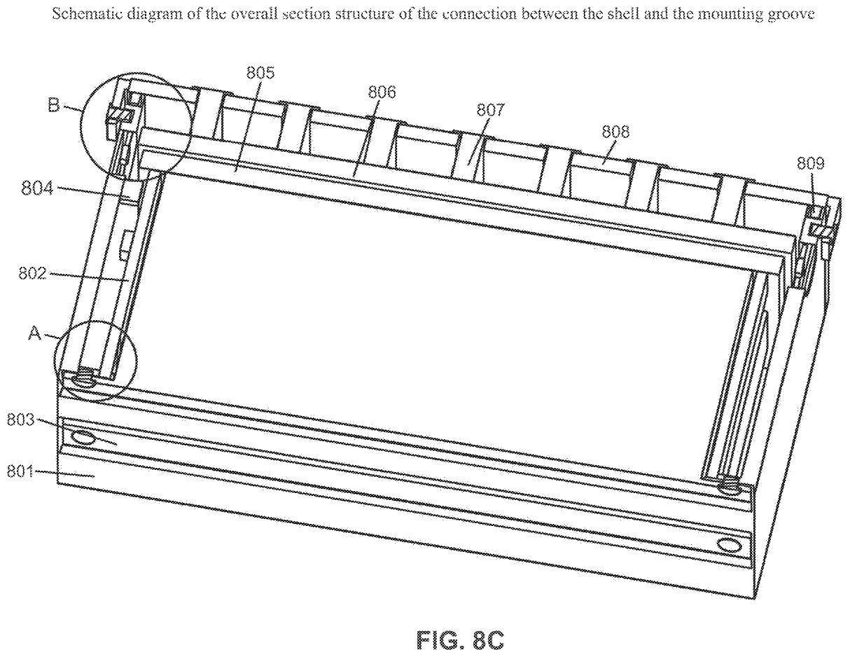

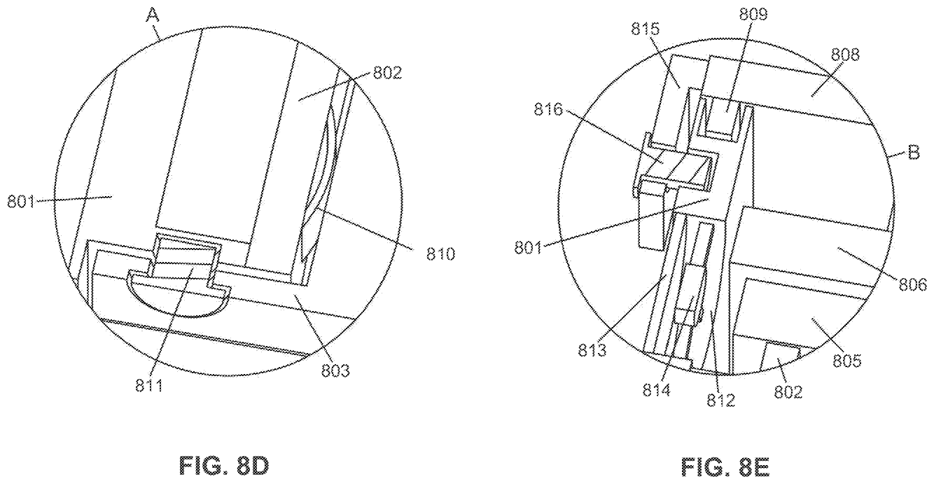

In some implementations, the dual-channel detection mechanism 500 includes a first channel configured to detect a mechanical state of a target component. This first channel includes a mechanical detect block 502. As illustrated with further details in FIGS. 8A-8E, the mechanical detect block 502 can be physically implemented as a presence switch, a detect pin, or a similar mechanical contact located within a connector interface, such as the connector circuit 116 or the connectors 117 of FIG. 1. As the target component is physically inserted into the connector, the mechanical detect block 502 can be physically actuated to generate a presence signal 504. The presence signal 504 serves as an initial hardware-level indication that a mechanical mating process has commenced.

Concurrently or sequentially, the dual-channel detection mechanism 500 can utilize a second channel configured to detect an electrical state of the target component. The second channel includes an electrical detect block 506. The electrical detect block 506 can monitor various electrical parameters to determine a voltage, current, and link status 508 of the connection. For example, the electrical detect block 506 can monitor specific power rails—such as a 5V, a 3.3V, or a 12V supply line—and evaluate signal stability to detect a “power good” state or a link readiness. This provides the technical advantage of verifying that the target component is not merely physically seated, but is also electrically capable of safe operation without causing an electrical fault on a system bus.

The presence signal 504 and the voltage, current, and link status 508 can then be fed into a validation logic 510. The validation logic 510 can be executed by a controller, such as the delay isolation logic 306 of FIG. 3, which is handled by the controller 103 (e.g., the CPLD 115, the MCU 113, or the BMC 112) of FIG. 1. The validation logic 510 evaluates the received inputs and is configured to proceed only when both the first channel and the second channel satisfy preset conditions simultaneously.

Within the validation logic 510, the controller can enforce a preset delay isolation window after the first channel detects the mechanical state and prior to executing any downstream power enablement. This delay isolation window can be implemented as a fixed millisecond-level timer. Alternatively, the preset delay isolation window can be dynamically adjusted based on a state stable judgment that continuously evaluates a real-time voltage and a signal stability from the electrical detect block 506. The combination of the validation logic 510 and the delay isolation window provides the critical technical advantage of physically and logically isolating the controller from transient mechanical contact bounce and electrical jitter, thereby averting false event triggers and potential arcing during the physical insertion.

Upon successful verification by the validation logic 510, the dual-channel detection mechanism 500 generates a valid insertion event 512. The valid insertion event 512 corresponds to the insertion event signal that is ultimately received by the controller to trigger downstream mitigation responses. In some cases, generating the valid insertion event 512 outputs the insertion event signal to trigger the synchronized power control and thermal control responses, such as those described in step 412 (trigger power control) and step 414 (trigger thermal pre-conditioning) of FIG. 4. The dual-channel detection mechanism 500 ensures that the computing device only initiates a transient power suppression protocol and a thermal pre-conditioning protocol when a secure, fully validated hot-swap connection is established.

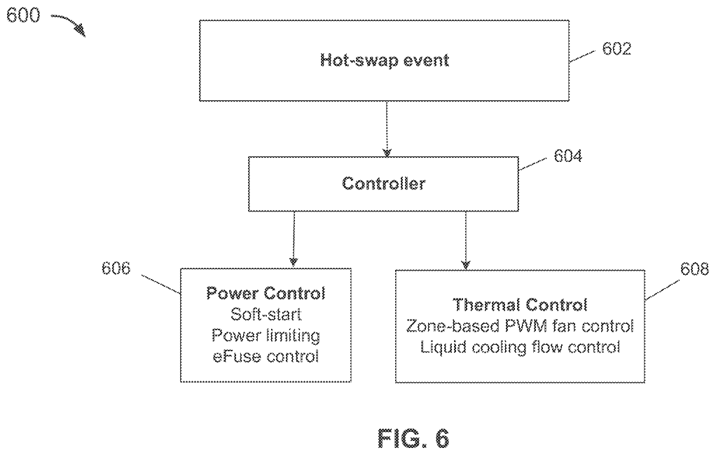

FIG. 6 illustrates an example hot-swap event based control mechanism 600 for coordinated power and thermal responses. The coordinated control mechanism 600 can establish a proactive, event-driven data flow that synchronizes power and thermal mitigation protocols at a system level. Some hot-swap implementations are largely passive and operate their power and cooling subsystems independently in silos, only reacting after an electrical or thermal disturbance has already occurred. In contrast, the coordinated control mechanism 600 can utilize a unified trigger to simultaneously drive mitigation efforts, providing the technical advantage of preventing localized heat load mutations and suppressing transient current shocks before a new component reaches steady-state operation.

The coordinated control mechanism 600 begins with a hot-swap event 602. The hot-swap event 602 corresponds to the valid insertion event 512 generated and outputted by the dual-channel detection mechanism 500 illustrated in FIG. 5. A controller 604 receives the hot-swap event 602. The controller 604 can be physically implemented as the controller 103 of FIG. 1, which includes the Baseboard Management Controller (BMC) 112, the microcontroller unit (MCU) 113, and the complex programmable logic device (CPLD) 115, or as the controller 308 of FIG. 3. Upon receiving the hot-swap event 602, the controller 604 can use this verified insertion event signal as a unified trigger source to simultaneously drive parallel execution blocks, specifically a power control block 606 and a thermal control block 608. This simultaneous triggering provides the technical advantage of isolating a computing device from hardware faults by proactively initiating mitigation responses before electrical and thermal loads are fully established on a system bus.

In response to receiving the hot-swap event 602, the controller 604 can command the power control block 606 to execute a transient power suppression protocol. The power control block 606 can be physically implemented by the power supply 108 and the voltage regulator (VR) 110 of FIG. 1. The transient power suppression protocol includes a soft-start sequence. During this soft-start sequence, the power control block 606 ramps up a supply voltage of the power supply to the target component according to a predetermined slope via a power path, which can include metal-oxide-semiconductor field-effect transistors (MOSFETs) or eFuse control. Concurrently, the transient power suppression protocol includes a power limiting aspect. The power control block 606 monitors real-time current and enforces a strict peak current limit during the soft-start sequence. Enforcing this strict peak current limit provides the technical advantage of suppressing transient inrush currents that could cause bus voltage drops and potentially crash adjacent online devices.

Simultaneously with commanding the power control block 606, the controller 604 can command the thermal control block 608 to execute a thermal pre-conditioning protocol. The thermal control block 608 can be physically implemented as the thermal control module 120 of FIG. 1 and the cooling module 235 of FIG. 2. The thermal pre-conditioning protocol includes increasing a cooling capacity of a physical zone corresponding to the target component. For example, increasing the cooling capacity can involve executing a zone-based pulse-width modulation (PWM) fan control or executing a liquid cooling flow control.

Crucially, the thermal pre-conditioning protocol dictates a temporal limitation wherein the controller 604 increases the cooling capacity based on the hot-swap event 602 and strictly prior to the supply voltage to the target component being fully established by the power control block 606. Conventional systems typically rely on closed-loop temperature sensors that exhibit thermal lag, rendering them unable to respond until after a component's heat load has spiked. In contrast, increasing the cooling capacity prior to voltage establishment provides the significant technical advantage of physically building a pre-cooled environment ahead of the actual heat load mutation. This preemptive approach effectively eliminates the thermal lag inherent in reactive closed-loop cooling systems, suppressing sudden temperature spikes and ensuring long-term hardware reliability.

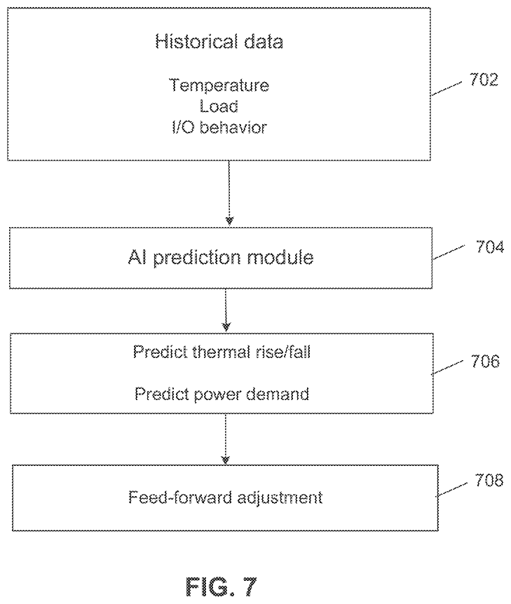

FIG. 7 is a flow chart of a process 700 of an artificial intelligence (AI) predictive module. The process 700 illustrates an AI predictive enhancement workflow that operates in conjunction with the hot-swap event-driven control architecture to dynamically enhance (or optimize) system responses. The AI prediction module 704 can be physically implemented as firmware or software instructions executed by a controller, such as the Baseboard Management Controller (BMC) 112, the microcontroller unit (MCU) 113 of FIG. 1, or by a dedicated machine learning accelerator coupled to the system bus. By leveraging machine learning models to anticipate thermal and electrical fluctuations, the process 700 provides the technical advantage of elevating a computing device from a static, rule-based response framework to an intelligent, adaptive architecture that optimally scales mitigation efforts and minimizes energy waste.

The process 700 begins with the ingestion of historical data 702. The historical data 702 serves as the foundational input feature set for the AI prediction module 704. The historical data 702 can include a variety of operating parameters, including at least one of a CPU/GPU utilization rate, a hard disk I/O throughput, a chassis inlet temperature, and/or a historical temperature curve representing a temporal sequence of thermal states. In some implementations, the historical data 702 can be continuously buffered in a local memory unit. When a valid insertion event signal is received, the AI prediction module 704 transitions into an event-triggered mode and instantly captures a snapshot of the buffered historical data 702 to formulate a predictive baseline.

Upon ingesting the historical data 702, the AI prediction module 704 executes inference operations to generate predictions 706, which can include predicting a thermal rise and predicting a power demand (e.g., a load trend) of the newly inserted target component. To generate these predictions 706, the AI prediction module 704 can utilize one or more machine learning models, including at least one of a Long Short-Term Memory (LSTM) model, a K-Nearest Neighbors (KNN) model, a Random Forest model, or a Neural Network. For example, the AI prediction module 704 can utilize an LSTM model, which is highly suited for processing continuous time-series data involving temporal dependencies, to predict a gradual temperature rise curve over a subsequent (e.g., 5 to10 minutes) window. Alternatively, in scenarios where limited historical workload data is available for a specific hardware slot, the AI prediction module 704 can employ gradient-boosting models, such as Extreme Gradient Boosting (XGBoost) or LightGBM. These gradient-boosting techniques handle sparse or irregular data highly effectively, providing the technical advantage of generating rapid, highly accurate short-term forecasts (e.g., within 1 to 3 minutes) of the immediate power demand required by the target component upon insertion.

Based on the predictions 706, the AI prediction module 704 outputs a feed-forward adjustment 708. The feed-forward adjustment 708 can act as a dynamic tuning parameter provided directly to the controller executing the hot-swap mitigation. Specifically, the feed-forward adjustment 708 dynamically adjusts an amplitude of a thermal pre-conditioning protocol and a power limiting threshold of a transient power suppression protocol. For instance, if the AI prediction module 704 predicts a severe load trend associated with a high-power GPU insertion, the feed-forward adjustment 708 may dictate a 30% preemptive increase in fan speed, whereas a predicted light load trend for a standard storage drive may only dictate a 10% increase. Utilizing the feed-forward adjustment 708 provides the technical advantage of precisely tailoring the cooling and power resource allocation to the specific device type being inserted, thereby avoiding overcompensation and conserving overall system energy.

To enhance adaptability across large-scale data center environments, the AI prediction module 704 can be configured to operate within a federated learning architecture. Under this architecture, the AI prediction module 704 can locally train its prediction models using the historical data 702 specific to its host computing device. Instead of transmitting raw, potentially sensitive historical operating data across a network, the AI prediction module 704 can upload only the updated model weights to a central coordinating node (e.g., a data center management server). The central coordinating node aggregates weights from multiple computing devices to update a global model, which is subsequently redistributed. Furthermore, when a new type of target component is inserted, the AI prediction module 704 can apply transfer learning or warm-start techniques, initializing the local model using model weights obtained from previously trained devices of a similar configuration. The combination of federated learning and warm-start techniques provides the technical advantage of significantly improving cross-environment adaptability and rapid model convergence while strictly preserving data privacy and minimizing network bandwidth overhead.

In addition to load and thermal forecasting, the AI prediction module 704 can be configured to execute anomaly detection and lifecycle monitoring. The AI prediction module 704 can utilize a regression model to predict a remaining lifespan of a cooling component (e.g., a fan or a liquid pump) based on an accumulated high-speed operation time and a temperature overage detected during historical hot-swap events. When the predicted remaining lifespan falls below a predefined threshold, the AI prediction module 704 generates a planned maintenance alert. Furthermore, the AI prediction module 704 can implement an Isolation Forest model or an autoencoder model to detect statistical outliers in operational data, thereby identifying anomalies such as impending fan stalls or micro-leaks in a liquid cooling loop before catastrophic failure occurs. This predictive health monitoring provides the technical advantage of facilitating preventative maintenance, drastically reducing emergency shutdown rates, and ensuring the long-term structural integrity of the computing device's thermal infrastructure.

FIGS. 8A-8E illustrate an example physical system 800 configured for the detection of a mechanical state of a hot-swap component and the stabilization of physical connections. The physical system 800 can provide the structural and electromechanical foundation for implementing the proactive, event-driven control architecture described in FIGS. 1 to 7. By integrating auxiliary connectivity stabilization structures, the physical system 800 can provide the technical advantage of physically dampening mechanical contact bounce, which synergistically shortens the delay isolation window required by the controller to verify an insertion event.

As illustrated across FIGS. 8A to 8E, the physical system 800 includes a mechanical housing such as a shell 801, configured to receive a target component like a hard disk 803 (as an example of the target component). The hard disk 803 can be a hot-swap component 302 of FIG. 3 or ne of the electronic components 215 of FIG. 2. The shell 801 can include one or more mounting slots, or mounting grooves 802, into which the hard disk 803 is slidably inserted. To ensure mechanical and electrical stability during the insertion process, the mechanical housing can further include an elastic shrapnel 810 and a fixed rod 811 (e.g., a threaded fixing rod). The elastic shrapnel 810 is positioned to apply a continuous biasing force against the hard disk 803 within the mounting grooves 802, while the fixed rod 811 can be rotated to threadably secure a front outer side of the hard disk 803 to the shell 801.

The combination of the elastic shrapnel 810 and the fixed rod 811 can provide a continuous contact pressure to the target component during the physical insertion. This continuous contact pressure provides the critical technical advantage of physically dampening mechanical contact bounce and transient electrical jitter at the physical interface. By minimizing physical jitter, this mechanical stabilization synergistically improves the signal clarity of the detection channels, allowing the computing device to safely utilize a shorter delay isolation window (as described in step 408 of FIG. 4 and block 510 of FIG. 5) before executing high-power enablement. In some implementations, the elastic shrapnel 810 or the fixed rod 811 can also provide a preliminary electrical function, such as serving as an early ground or an electrostatic discharge path, further stabilizing the electrical state of the target component prior to full data-link engagement.

To detect the physical insertion of the hard disk 803, the shell 801 houses a hot-swappable switch 804. The hot-swappable switch 804 can act as the physical hardware implementation of the mechanical detect block 502 described in FIG. 5. As the hard disk 803 is fully seated into the mounting grooves 802, it actuates the hot-swappable switch 804, which generates the presence signal 504 serving as the first channel of the dual-channel detection mechanism. The hot-swappable switch 804 is communicatively coupled to a motherboard 805 (corresponding to the MB 104 of FIG. 1), which routes the presence signal to the controller for evaluation.

The physical system 800 can also integrate hardware to facilitate the thermal control responses generated by the controller. A thermal conductive plate 806 is physically coupled to a rear side of the motherboard 805. The thermal conductive plate 806 transfers heat to one or more heat dissipation fins 807. To drive forced convection across these components, the shell 801 includes a heat dissipation port 812 that houses a micro fan 814 (corresponding to the air cooling device 220 of FIG. 2) and a filter 813. When the controller executes the thermal pre-conditioning protocol (step 414 of FIG. 4), the micro fan 814 is preemptively spooled up to actively draw heat away from the thermal conductive plate 806 and the heat dissipation fins 807, providing the technical advantage of rapidly building a pre-cooled environment for the hard disk 803 before its thermal load peaks.

To facilitate efficient maintenance and rapid part replacement, the shell 801 incorporates a quick disassembly structure. The quick disassembly structure includes a rear cover plate 808, a limit block 809, a fixed plate 815 (e.g., an L-shaped fixing plate), and a mounting rod 816 (e.g., a threaded installation rod). The rear cover plate 808 is secured to the shell 801 via a snap-fit connection utilizing the limit block 809. The mounting rod 816 is threadably connected to an outer end of the fixed plate 815. By rotating the mounting rod 816, the rear cover plate 808 and the limit block 809 can be swiftly separated from the shell 801. Pulling the rear cover plate 808 backward simultaneously separates the fixed plate 815 and the thermal conductive plate 806 from the interior rear of the shell 801. This modular configuration provides the technical advantage of facilitating rapid separation and direct maintenance access to the heat conduction plate and internal computing components, thereby significantly reducing maintenance downtime and operational overhead in high-density data centers.

FIG. 9 is a block diagram illustrating an example architecture of a computing device 900 used to provide computational functionalities associated with described algorithms, methods, functions, processes, flows, and procedures. Other architectures are possible, including architectures with more or fewer components. The computing device can be implemented as the computing device 100 of FIG. 1, the computing device 200 of FIG. 2, the computing device as described with respect to FIGS. 3-7, or the computing device with respect to FIGS. 8A-8E. The computing device 900 includes processor 904, memory 906, storage component 908, input interface 910, output interface 912, communication interface 914, and bus 902.

Bus 902 includes a component that permits communication among the components of the computing device 900. In some embodiments, processor 904 is implemented in hardware, software, or a combination of hardware and software. In some examples, processor 904 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 906 includes random access memory (RAM), read-only memory (ROM), and/or another type of dynamic and/or static storage device (e.g., flash memory, magnetic memory, optical memory, and/or the like) that stores data and/or instructions for use by processor 904.

Storage component 908 stores data and/or software related to the operation and use of the computing device 900. In some examples, storage component 908 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 910 includes a component that permits the computing device 900 to receive information, such as via user input (e.g., a touchscreen display, a keyboard, a keypad, a mouse, a button, a switch, a microphone, a camera, and/or the like). Additionally or alternatively, in some embodiments input interface 910 includes a sensor that senses information (e.g., a global positioning system (GPS) receiver, an accelerometer, a gyroscope, an actuator, and/or the like). Output interface 912 includes a component that provides output information from the computing device 900 (e.g., a display, a speaker, one or more light-emitting diodes (LEDs), and/or the like).

In some embodiments, communication interface 914 includes a transceiver-like component (e.g., a transceiver, a separate receiver and transmitter, and/or the like) that permits the computing device 900 to communicate with other devices via a wired connection, a wireless connection, or a combination of wired and wireless connections. In some examples, communication interface 914 permits the computing device 900 to receive information from another device and/or provide information to another device. In some examples, communication interface 914 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, the computing device 900 performs one or more processes described herein. The computing device 900 performs these processes based on processor 904 executing software instructions stored by a computer-readable medium, such as memory 906 and/or storage component 908. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 906 and/or storage component 908 from another computer-readable medium or another device via communication interface 914. When executed, software instructions stored in memory 906 and/or storage component 908 cause processor 904 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 906 and/or storage component 908 includes data storage or at least one data structure (e.g., a database and/or the like). The computing device 900 is capable of receiving information from, storing information in, communicating information to, or searching information stored in the data storage or the at least one data structure in memory 906 or storage component 908. In some examples, the information includes network data, input data, output data, or any combination thereof.

In some embodiments, the computing device 900 is configured to execute software instructions that are either stored in memory 906 and/or in the memory of another device (e.g., another device that is the same as or similar to the computing device 900). As used herein, the term “module” refers to at least one instruction stored in memory 906 and/or in the memory of another device that, when executed by processor 904 and/or by a processor of another device (e.g., another device that is the same as or similar to the computing device 900) cause the computing device 900 (e.g., at least one component of the computing device 900) to perform one or more processes described herein. In some embodiments, a module is implemented in software, firmware, hardware, and/or the like.

The number and arrangement of components illustrated in FIG. 9 are provided as an example. In some embodiments, the computing device 900 can include additional components, fewer components, different components, or differently arranged components than those illustrated in FIG. 9. Additionally, or alternatively, a set of components (e.g., one or more components) of the computing device 900 can perform one or more functions described as being performed by another component or another set of components of the computing device 900.

FIG. 10 illustrates an example architecture 1000 of a computing system used to provide computational functionalities associated with described algorithms, methods, functions, processes, flows, and procedures. The computing system can include one or more computing devices such as the computing device 100 of FIG. 1 or the computing device 200 of FIG. 2, the computing device as described with respect to FIGS. 3-7, or the computing device with respect to FIGS. 8A-8E. Other architectures are possible, including architectures with more or fewer components.

In some implementations, architecture 1000 includes one or more processor(s) 1002 (e.g., dual-core Intel® Xeon® Processors), one or more network interface(s) 1006, one or more storage device(s) 1004 (e.g., hard disk, optical disk, flash memory) and one or more computer-readable medium(s) 1008 (e.g., hard disk, optical disk, flash memory, etc.). These components can exchange communications and data over one or more communication channel(s) 1010 (e.g., buses), which can utilize various hardware and software for facilitating the transfer of data and control signals between components.

The term “computer-readable medium” refers to any medium that participates in providing instructions to the processor(s) 1002 for execution, including without limitation, non-volatile media (e.g., optical or magnetic disks), volatile media (e.g., memory) and transmission media. Transmission media includes, without limitation, coaxial cables, copper wire, and fiber optics.

Computer-readable medium(s) 1008 can further include instructions 1012 for an operating system (e.g., Mac OS® server, Windows® NT server, Linux Server), instructions 1014 for network communications module, data processing instructions 1016, and interface instructions 1018.

Operating systems can be multi-user, multiprocessing, multitasking, multithreading, real time, etc. Operating system performs basic tasks, including but not limited to: recognizing input from and providing output to devices 1002, 1004, 1006 and 1008; keeping track and managing files and directories on computer-readable medium(s) 1008 (e.g., memory or a storage device); controlling peripheral devices; and managing traffic on the one or more communication channel(s) 1010. Network communications module includes various components for establishing and maintaining network connections (e.g., software for implementing communication protocols, such as TCP/IP, HTTP, etc.) and for creating a distributed streaming platform using, for example, Apache Kafka™. Data processing instructions 1016 include server-side or backend software for implementing the server-side operations. Interface instructions 1018 includes software for implementing a web server and/or portal for sending and receiving data to and from user side computing devices and service provider side computing devices.

Architecture 1000 can be implemented by a cloud computing system and can be included in any computing device, including one or more server computers in a local or distributed network each having one or more processing cores. Architecture 1000 can be implemented in a parallel processing or peer-to-peer infrastructure or on a single device with one or more processors. Software can include multiple software components or can be a single body of code.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While t he requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 902.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include one or more clients (e.g., client computing devices) and one or more servers (server computing devices). A client and server are generally remote from each other and typically interact through a communication network. The relationship of client and server arises by virtue of computer programs running on the respective computers and having a client-server relationship to each other.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

It is noted that references in the present disclosure to “one embodiment,” “an embodiment,” “an example embodiment,” “some implementations,” “some implementations,” etc., indicate that the embodiment described can include a particular feature, structure, or characteristic, but every embodiment can not necessarily include the particular feature, structure, or characteristic. Moreover, such phrases do not necessarily refer to the same embodiment. Further, when a particular feature, structure or characteristic is described in connection with an embodiment, it would be within the knowledge of a person skilled in the pertinent art to affect such feature, structure or characteristic in connection with other implementations whether or not explicitly described.

As used herein, the term “nominal/nominally” refers to a desired, or target, value of a characteristic or parameter for a component or a process step, set during the design phase of a product or a process, together with a range of values above and/or below the desired value. As used herein, the range of values can be due to slight variations in manufacturing processes or tolerances.

As used herein, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or, A and B.” As used herein, the term “and/or” as used herein refers to and encompasses any and all possible combinations of one or more of the associated listed terms. For example, the term “A and/or B” means that either option A, option B, or both options A and B are possible, where A and B may be singular or plural.

As used herein, the term “about” or “approximately” can allow for a degree of variability in a value or range, for example, within 10%, within 5%, or within 1% of a stated value or of a stated limit of a range. As used herein, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

In addition, the phraseology or terminology employed in the present disclosure, and not otherwise defined, is for the purpose of description only and not of limitation. Any use of section headings is intended to aid reading of the document and is not to be interpreted as limiting; information that is relevant to a section heading may occur within or outside of that particular section.

The following numbered paragraphs are non-limiting examples of various embodiments of the present disclosure.

Embodiment 1. A device, comprising: a hot-swap detection module configured to detect a physical movement of a target component into the device and generate an event signal; a power control module configured to regulate a power supply to the target component; a thermal control module configured to regulate a cooling capacity of a physical zone corresponding to the target component; and a controller communicatively coupled to the hot-swap detection module, the power control module, and the thermal control module, wherein the controller is configured to: receive the event signal from the hot-swap detection module; and in response to receiving the event signal, coordinate a power control response and a thermal control response.

Embodiment 2. The device of embodiment 1, wherein the physical movement comprises a physical insertion, and the event signal comprises an insertion event signal, and wherein the controller is configured to coordinate the power control response and the thermal control response by: commanding the power control module to execute a transient power suppression protocol, wherein the transient power suppression protocol comprises ramping up a supply voltage of the power supply to the target component, and commanding the thermal control module to execute a thermal pre-conditioning protocol, wherein the thermal pre-conditioning protocol comprises increasing the cooling capacity of the physical zone based on the insertion event signal and prior to the supply voltage to the target component being fully established by the transient power suppression protocol.

Embodiment 3. The device of embodiment 2, wherein increasing the cooling capacity comprises preemptively increasing a fan pulse-width modulation (PWM) duty cycle by a percentage, and wherein the power control module is configured to utilize a proportional-integral-derivative (PID) algorithm to maintain a voltage regulation accuracy during the transient power suppression protocol.

Embodiment 4. The device of embodiment 2 or 3, wherein the hot-swap detection module comprises a first channel configured to detect a mechanical state of the target component and a second channel configured to detect an electrical state of the target component, and wherein the controller is configured to register the insertion event signal only when both the first channel and the second channel satisfy preset conditions simultaneously.

Embodiment 5. The device of embodiment 4, wherein the controller is further configured to enforce a preset delay isolation window after the first channel detects the mechanical state and prior to executing the transient power suppression protocol.

Embodiment 6. The device of embodiment 5, wherein the preset delay isolation window is dynamically adjusted based on a state stable judgment that continuously evaluates a real-time voltage and a signal stability prior to executing the transient power suppression protocol.

Embodiment 7. The device of any one of embodiments 2 to 6, wherein the transient power suppression protocol comprises a soft-start sequence configured to: ramp up the supply voltage according to a predetermined slope, and monitor real-time current and enforce a peak current limit during the soft-start sequence.

Embodiment 8. The device of any one of embodiments 1 to 7, wherein the physical movement comprises a physical removal, and the event signal comprises a removal event signal, and wherein, in response to the removal event signal from the hot-swap detection module, the power control module is configured to prioritize rapid current limiting or power path shutdown prior to physical disconnection of the target component.

Embodiment 9. The device of any one of embodiments 1 to 8, further comprising a predictive module configured to operate in an event-triggered mode, wherein the predictive module is configured to: receive the event signal; analyze historical operating data to predict at least one of a load trend or a temperature rise or fall of the target component; and provide a feed-forward parameter to the controller to dynamically adjust an amplitude of a thermal pre-conditioning protocol and a power limiting threshold of a transient power suppression protocol.

Embodiment 10. The device of embodiment 9, wherein the historical operating data comprises at least one of a CPU/GPU utilization rate, a hard disk I/O throughput, a chassis inlet temperature, or a historical temperature curve, and wherein the predictive module utilizes a machine learning model comprising at least one of a Long Short-Term Memory (LSTM) model, a K-Nearest Neighbors (KNN) model, a Random Forest model, a Neural Network, or an Isolation Forest model.

Embodiment 11. The device of any one of embodiments 1 to 10, wherein the controller is further configured to transition the thermal control module from a thermal pre-conditioning protocol to a reactive closed-loop proportional-integral-derivative (PID) control based on real-time temperature sensor data following stabilization of the target component.

Embodiment 12. The device of any one of embodiments 1 to 11, wherein the controller is configured to acquire real-time operating data for closed-loop monitoring, the real-time operating data comprising fan speed data acquired via a TACH signal, temperature data acquired via an I2C interface sensor, and current or voltage data acquired via a monitoring chip utilizing an I2C or PMBus interface.

Embodiment 13. The device of any one of embodiments 1 to 12, wherein the controller is configured to: in response to detecting an anomaly condition comprising at least one of a rapid over-temperature, a severe voltage drop, or a half-insertion fault, trigger a safe mode that forces the thermal control module to a full cooling capacity, reduce a power output limit of the power control module, and transmit a maintenance alert.

Embodiment 14. The device of embodiment 2 or 3, wherein the thermal pre-conditioning protocol comprises selectively increasing the cooling capacity strictly in the physical zone corresponding to the target component.

Embodiment 15. The device of embodiment 14, wherein increasing the cooling capacity comprises increasing a fan pulse-width modulation (PWM) duty cycle or adjusting a liquid cooling flow rate.

Embodiment 16. The device of any one of embodiments 1 to 15, wherein the target component comprises at least one of a U.2 storage module, a U.3 storage module, an E1.S storage module, an E3.S storage module, a Peripheral Component Interconnect Express (PCIe) expansion card, a graphics processing unit (GPU), or a network interface controller (NIC).

Embodiment 17. A device, comprising: a hot-swap detection module comprising a first channel configured to detect a mechanical state of a target component and a second channel configured to detect an electrical state of the target component, wherein the hot-swap detection module is configured to detect a physical movement of the target component into the device and generate an event signal based on the mechanical state and the electrical state; a power control module configured to regulate a power supply to the target component; and a controller communicatively coupled to the hot-swap detection module and the power control module, wherein the controller is configured to: receive the event signal from the hot-swap detection module; and in response to receiving the event signal, generate a power control response for the target component.

Embodiment 18. The device of embodiment 17, wherein the controller is configured to register the insertion event signal only when both the first channel and the second channel satisfy preset conditions simultaneously.

Embodiment 19. The device of embodiment 17 or 18, wherein the physical movement comprises a physical insertion, and the event signal comprises an insertion event signal, and wherein the controller is configured to generate the power control response for the target component by commanding the power control module to execute a transient power suppression protocol, wherein the transient power suppression protocol comprises ramping up a supply voltage of the power supply to the target component.

Embodiment 20. The device of embodiment 19, wherein the controller is further configured to enforce a preset delay isolation window after the first channel detects the mechanical state and prior to executing the transient power suppression protocol.

Embodiment 21. The device of embodiment 19 or 20, wherein the transient power suppression protocol comprises a soft-start sequence configured to: ramp up the supply voltage according to a predetermined slope via a power path, and monitor real-time current and enforce a strict peak current limit during the soft-start sequence.

Embodiment 22. The device of any one of embodiments 17 to 21, wherein the physical movement comprises a physical removal, and the event signal comprises a removal event signal, and wherein, in response to the removal event signal from the hot-swap detection module, the power control module is configured to prioritize rapid current limiting or power path shutdown prior to physical disconnection of the target component.

Embodiment 23. The device of any one of embodiments 17 to 22, further comprising a thermal control module configured to regulate a cooling capacity of a physical zone corresponding to the target component, wherein the controller is communicatively coupled to the thermal control module and configured to: in response to receiving the event signal from the hot-swap detection module, generate a thermal control response for the target component.

Embodiment 24. The device of embodiment 23, wherein the physical movement comprises a physical insertion, and the event signal comprises an insertion event signal, and wherein the controller is configured to coordinate the power control response and the thermal control response by: commanding the power control module to execute a transient power suppression protocol, wherein the transient power suppression protocol comprises ramping up a supply voltage of the power supply to the target component, and commanding the thermal control module to execute a thermal pre-conditioning protocol, wherein the thermal pre-conditioning protocol comprises increasing the cooling capacity of the physical zone based on the insertion event signal and prior to the supply voltage to the target component being fully established by the transient power suppression protocol.

Embodiment 25. The device of embodiment 24, wherein the controller is further configured to transition the thermal control module from the thermal pre-conditioning protocol to a reactive closed-loop proportional-integral-derivative (PID) control based on real-time temperature sensor data following stabilization of the target component.

Embodiment 26. The device of any one of embodiments 23 to 25, further comprising a predictive module configured to operate in an event-triggered mode, wherein the predictive module is configured to: receive the event signal; analyze historical operating data to predict a load trend and a temperature rise or fall of the target component; and provide a feed-forward parameter to the controller to dynamically adjust an amplitude of a thermal pre-conditioning protocol and a power limiting threshold of a transient power suppression protocol.

Embodiment 27. The device of embodiment 26, wherein the predictive module is configured to operate within a federated learning architecture, and wherein the predictive module is configured to locally train a prediction model and upload model weights to a central coordinating node without sharing raw historical operating data to improve cross-environment adaptability.

Embodiment 28. The device of embodiment 26 or 27, wherein the predictive module is further configured to utilize a regression model to predict a remaining lifespan of a cooling component based on an accumulated high-speed operation time and a temperature overage, and generate a planned maintenance alert when the remaining lifespan falls below a predefined threshold.

Embodiment 29. The device of any one of embodiments 23 to 28, wherein the thermal control module comprises a plurality of fans within the physical zone, and wherein, in response to a failure of a single fan among the plurality of fans, the thermal control module is configured to automatically execute a redundancy compensation by dynamically increasing a speed of adjacent fans to maintain an overall cooling efficiency.

Embodiment 30. The device of any one of embodiments 17 to 29, wherein the event signal comprises a connection status between the target component and the device indicating operational states of multiple units within the target component, and wherein the controller is configured to generate the power control response and a thermal control response based on the connection status to dynamically adjust a power output and a cooling capability to save power for inactive units.

Embodiment 31. The device of any one of embodiments 17 to 30, wherein the controller comprises at least one of a Baseboard Management Controller (BMC), a Complex Programmable Logic Device (CPLD), or a Microcontroller Unit (MCU).

Embodiment 32. The device of any one of embodiments 17 to 31, further comprising a mechanical housing configured to receive the target component, wherein the mechanical housing comprises a mounting slot, an elastic shrapnel, and a threaded fixing rod, wherein the elastic shrapnel and the threaded fixing rod are configured to provide a continuous contact pressure to the target component during the physical movement.

Embodiment 33. The device of embodiment 32, wherein the mechanical housing further comprises a quick disassembly structure comprising a rear cover plate, a limit block, an L-shaped fixing plate, and a threaded installation rod configured to facilitate rapid separation and maintenance access to a heat conduction plate and internal components.

Embodiment 34. The device of any one of embodiments 17 to 33, wherein the controller is configured to upload transient current data and power consumption data to a management system, and receive a global energy scheduling command from the management system to enforce a staggered power-on delay or dynamically adjust a global power-limiting threshold during a simultaneous mass hot-swap event.

Embodiment 35. The device of embodiment 34, wherein the controller is further configured to communicate with the management system via a standard communication protocol comprising at least one of IPMI, Redfish, SNMP, Modbus, or BACnet.

Embodiment 36. A method for managing a hot-swap event in a device, the method comprising: detecting, via a hot-swap detection module, a physical movement of a target component into the device; generating an event signal based on the physical movement; receiving, by a controller, the event signal; and in response to receiving the event signal, coordinating a power control response and a thermal control response by commanding a power control module to regulate a power supply to the target component and commanding a thermal control module to regulate a cooling capacity of a physical zone corresponding to the target component.

Embodiment 37. The method of embodiment 36, wherein detecting the physical movement comprises verifying a mechanical state of the target component via a first channel and verifying an electrical state of the target component via a second channel, and registering the insertion event signal only when both the first channel and the second channel satisfy preset conditions simultaneously.

Embodiment 38. The method of embodiment 37, wherein the physical movement comprises a physical insertion, and the event signal comprises an insertion event signal, and wherein the method further comprises enforcing a preset delay isolation window after the first channel detects the mechanical state and prior to coordinating the power control response and the thermal control response, thereby mitigating disturbances caused by the physical insertion.

Embodiment 39. The method of any one of embodiments 36 to 38, wherein coordinating the power control response and the thermal control response comprises: executing a transient power suppression protocol by ramping up a supply voltage to the target component according to a predetermined slope; and executing a thermal pre-conditioning protocol by increasing the cooling capacity of the physical zone prior to the supply voltage being fully established.

Embodiment 40. The method of any one of embodiments 36 to 39, further comprising: predicting a load trend and a temperature rise or fall of the target component using a predictive module based on historical operating data in response to the event signal; and dynamically adjusting an amplitude of the thermal control response and a power limiting threshold of the power control response based on the predicted load trend and the predicted temperature rise or fall. While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The breadth and scope of the present disclosure should not be limited by any of the above-described exemplary implementations, but should be defined only in accordance with the following claims and their equivalents.

1. A device, comprising:
a hot-swap detection module configured to detect a physical movement of a target component into the device and generate an event signal;
a power control module configured to regulate a power supply to the target component;
a thermal control module configured to regulate a cooling capacity of a physical zone corresponding to the target component; and
a controller communicatively coupled to the hot-swap detection module, the power control module, and the thermal control module,
wherein the controller is configured to:
receive the event signal from the hot-swap detection module; and
in response to receiving the event signal, coordinate a power control response and a thermal control response.

2. The device of claim 1, wherein the physical movement comprises a physical insertion, and the event signal comprises an insertion event signal, and
wherein the controller is configured to coordinate the power control response and the thermal control response by:
commanding the power control module to execute a transient power suppression protocol, wherein the transient power suppression protocol comprises ramping up a supply voltage of the power supply to the target component, and
commanding the thermal control module to execute a thermal pre-conditioning protocol, wherein the thermal pre-conditioning protocol comprises increasing the cooling capacity of the physical zone based on the insertion event signal and prior to the supply voltage to the target component being fully established by the transient power suppression protocol.

3. The device of claim 2, wherein the hot-swap detection module comprises a first channel configured to detect a mechanical state of the target component and a second channel configured to detect an electrical state of the target component, and
wherein the controller is configured to register the insertion event signal only when both the first channel and the second channel satisfy preset conditions simultaneously.

4. The device of claim 3, wherein the controller is further configured to enforce a preset delay isolation window after the first channel detects the mechanical state and prior to executing the transient power suppression protocol.

5. The device of claim 2, wherein the transient power suppression protocol comprises a soft-start sequence configured to:
ramp up the supply voltage according to a predetermined slope, and
monitor real-time current and enforce a peak current limit during the soft-start sequence.

6. The device of claim 1, wherein the physical movement comprises a physical removal, and the event signal comprises a removal event signal, and
wherein, in response to the removal event signal from the hot-swap detection module, the power control module is configured to prioritize rapid current limiting or power path shutdown prior to physical disconnection of the target component.

7. The device of claim 1, further comprising a predictive module configured to operate in an event-triggered mode, wherein the predictive module is configured to:
receive the event signal;
analyze historical operating data to predict at least one of a load trend or a temperature rise or fall of the target component; and
provide a feed-forward parameter to the controller to dynamically adjust an amplitude of the thermal pre-conditioning protocol and a power limiting threshold of the transient power suppression protocol.

8. The device of claim 1, wherein the controller is further configured to transition the thermal control module from a thermal pre-conditioning protocol to a reactive closed-loop proportional-integral-derivative (PID) control based on real-time temperature sensor data following stabilization of the target component.

9. The device of claim 1, wherein the controller is configured to:
in response to detecting an anomaly condition comprising at least one of a rapid over-temperature, a severe voltage drop, or a half-insertion fault, trigger a safe mode that forces the thermal control module to a full cooling capacity, reduce a power output limit of the power control module, and transmit a maintenance alert.

10. A device, comprising:
a hot-swap detection module comprising a first channel configured to detect a mechanical state of a target component and a second channel configured to detect an electrical state of the target component, wherein the hot-swap detection module is configured to detect a physical movement of the target component into the device and generate an event signal based on the mechanical state and the electrical state;
a power control module configured to regulate a power supply to the target component; and
a controller communicatively coupled to the hot-swap detection module and the power control module,
wherein the controller is configured to:
receive the event signal from the hot-swap detection module; and
in response to receiving the event signal, generate a power control response for the target component.

11. The device of claim 10, wherein the physical movement comprises a physical insertion, and the event signal comprises an insertion event signal, and the controller is configured to register the insertion event signal only when both the first channel and the second channel satisfy preset conditions simultaneously.

12. The device of claim 10, wherein the physical movement comprises a physical insertion, and the event signal comprises an insertion event signal, and wherein the controller is configured to generate the power control response for the target component by commanding the power control module to execute a transient power suppression protocol, wherein the transient power suppression protocol comprises ramping up a supply voltage of the power supply to the target component.

13. The device of claim 12, wherein the controller is further configured to enforce a preset delay isolation window after the first channel detects the mechanical state and prior to executing the transient power suppression protocol.

14. The device of claim 12, wherein the transient power suppression protocol comprises a soft-start sequence configured to:
ramp up the supply voltage according to a predetermined slope via a power path, and monitor real-time current and enforce a strict peak current limit during the soft-start sequence.

15. The device of claim 10, further comprising a thermal control module configured to regulate a cooling capacity of a physical zone corresponding to the target component,
wherein the controller is communicatively coupled to the thermal control module and configured to:
in response to receiving the event signal from the hot-swap detection module, generate a thermal control response for the target component.

16. The device of claim 15, wherein the physical movement comprises a physical insertion, and the event signal comprises an insertion event signal, and wherein the controller is configured to coordinate the power control response and the thermal control response by
commanding the power control module to execute a transient power suppression protocol, wherein the transient power suppression protocol comprises ramping up a supply voltage of the power supply to the target component, and
commanding the thermal control module to execute a thermal pre-conditioning protocol, wherein the thermal pre-conditioning protocol comprises increasing the cooling capacity of the physical zone based on the insertion event signal and prior to the supply voltage to the target component being fully established by the transient power suppression protocol.

17. The device of claim 15, further comprising a predictive module configured to operate in an event-triggered mode, wherein the predictive module is configured to:
receive the event signal;
analyze historical operating data to predict a load trend and a temperature rise or fall of the target component; and
provide a feed-forward parameter to the controller to dynamically adjust an amplitude of the thermal pre-conditioning protocol and a power limiting threshold of the transient power suppression protocol.

18. The device of claim 11, further comprising a mechanical housing configured to receive the target component, wherein the mechanical housing comprises a mounting slot, an elastic shrapnel, and a threaded fixing rod,
wherein the elastic shrapnel and the threaded fixing rod are configured to provide a continuous contact pressure to the target component during the physical movement.

19. The device of claim 10, wherein the controller is configured to upload transient current data and power consumption data to a management system, and receive a global energy scheduling command from the management system to enforce a staggered power-on delay or dynamically adjust a global power-limiting threshold during a simultaneous mass hot-swap event.

20. A method for managing a hot-swap event in a device, the method comprising:
detecting, via a hot-swap detection module, a physical movement of a target component into the device;
generating an event signal based on the physical movement;
receiving, by a controller, the event signal; and
in response to receiving the event signal, coordinating a power control response and a thermal control response by commanding a power control module to regulate a power supply to the target component and commanding a thermal control module to regulate a cooling capacity of a physical zone corresponding to the target component.
